(19) United States
(12) Patent Application Publication
(10) Pub. No.: US 2007/0252937 A1
(43) Pub. Date: Nov. 1, 2007

(54) Lateral electric field type liquid-crystal display device

(75) Inventors: Teruaki Suzuki, Kanagawa (JP); Takayuki Konno, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC LCD TECHNOLOGIES, LTD., Kawasaki (JP)

(21) Appl. No.: 11/783,764

(22) Filed: Apr. 12, 2007

(30) Foreign Application Priority Data
Apr. 12, 2006 (JP) 109522/2006

(51) Int. Cl. G02F 1/1343

(52) U.S. Cl. 349/141

(57) ABSTRACT

A lateral electric field type liquid crystal display device prevents the generation of the reverse rotation domain when the reverse-rotation domain preventing structure using the floating electrodes is adopted. A first liquid-crystal driving electrode (e.g., pixel electrode) and a second liquid-crystal driving electrode (e.g., common electrode) comprise comb-tooth-like parts extending approximately parallel to each other and being meshed with each other, respectively, in a region where images are displayed by applying a liquid-crystal driving electric field to liquid crystal. An electrically isolated first floating electrode is provided in the vicinity of the top end of the comb-tooth-like part of the first liquid-crystal driving electrode, where the first floating electrode comprises an overlapped part which is overlapped with the top end by way of an insulating film. The capacitance intervening between the first floating electrode and the first liquid-crystal driving electrode is greater than the capacitance intervening between the first floating electrode and the second liquid-crystal driving electrode.

### BACKGROUND OF THE INVENTION

1. Field of the Invention

The present invention relates to a Liquid-crystal Display (LCD) device and more particularly, to a LCD device of the lateral electric field (In-Plane Switching, IPS) type.

2. Description of the Related Art

Generally, the LCD device has the feature of thin, lightweight, and low power consumption. In particular, the active-matrix addressing LCD (AM LCD) device that drives the respective pixels arranged in a matrix array with the active elements has ever been recognized as a high image quality flat panel display device. Especially, the AM LCD device using thin-film transistors (TFTs) (i.e., TFT-LCD) as the active elements has been extensively diffused.

Most of active-matrix addressing LCD devices, which utilize the electrooptic effects of the TN (Twisted Nematic) type liquid crystal sandwiched by two substrates, display images by applying an electric field approximately vertical to the surfaces of the substrates across the liquid crystal to thereby cause displacement of the liquid crystal molecules. These LCD devices are termed the “vertical electric field” type. On the other hand, some LCD devices display images by applying an electric field approximately parallel to the surfaces of the substrates to thereby cause displacement of the liquid crystal molecules in the planes parallel to the surfaces of the substrates. These LCD devices have been known also, which are termed the “lateral electric field” type. Various improvements have ever been made for the lateral electric field type LCD devices also. Some of the improvements will be exemplified below.

A structure using comb-tooth-like electrodes mated with each other in the lateral electric field type LCD device is disclosed in the U.S. Pat. No. 3,807,831 issued in 1974 (refer to claim 1, FIGS. 1 to 4 and FIG. 11).

A technique using comb-tooth-like electrodes mated with each other similar to those in the U.S. Pat. No. 3,807,831 in the active-matrix addressing LCD device utilizing the electrooptic effects of the TN type liquid crystal is disclosed in the Japanese Unexamined Patent Publication No. 56-091277 published in 1981 (refer to claim 2, FIG. 7 and FIGS. 9 to 13). This technique reduces the parasitic capacitance between the common electrode and the drain bus lines, or that between the common electrode and the gate lines.

A technique that realizes a lateral electric field type LCD device without the comb-tooth-like electrodes in the active-matrix addressing LCD device using TPTs is disclosed in the Japanese Unexamined Patent Publication No. 7-036058 published in 1995 (refer to claims 1 and 5, FIGS. 1 to 23). With this technique, the common electrode and the image signal electrodes or the common electrode and the liquid-crystal driving electrodes are formed on different layers and at the same time, the common electrode or the liquid-crystal driving electrodes is/are formed to be ring-, cross-, T-, ?-, H-, or ladder-shaped.

A structure that the pixel electrode and the common electrode for generating the liquid-crystal driving lateral electric field (both of which are comb-tooth-shaped) are disposed above (i.e., at closer positions to the liquid crystal layer) the bus lines (i.e., data lines) that supply signals to the active elements for driving the respective pixels, where an insulating layer intervenes between the pixel electrodes and the common electrode, is disclosed In the Japanese Unexamined Patent Publication No. 2002-323706 published in 2002 (refer to claim 1, first embodiment. FIGS. 1 to 2). It is said that with this structure, since the electric field from the bus lines can be shielded by forming the common electrode to cover the bus lines, defective display caused by vertical crosstalk is prevented. Moreover, it is said that the aperture ratio is raised by forming the common electrode with a transparent conductive material.

FIGS. 1 and 2 are drawing figures explaining an example of the structure of a prior-art popular lateral electric field type active-matrix addressing LCD device. FIG. 1 is a plan view of the device, FIG. 2A is a cross-sectional view along the line IIA-IIA in FIG. 1, and FIG. 2B is a cross-sectional view along the line IIB-IIB in FIG. 1. Moreover, FIGS. 3A and 3B and FIGS. 4A and 4B are partial plan views showing the fabrication steps of the said LCD device. All of these figures show the structure of one pixel region.

With the prior-art LCD device, as shown in FIGS. 1 and 3B, rectangular regions are formed by gate bus lines 155 extending along the horizontal direction of FIGS. 1 and 3B and drain bus lines 156 extending along the vertical direction thereof. Pixel regions are formed in the respective rectangular regions. Pixels are arranged in a matrix array as a whole. Common bus lines 153 are formed to extend along the horizontal direction of FIGS. 1 and 3B, similar to the gate bus lines 155. At the respective intersections of the gate and drain bus lines 155 and 156. TFTs 145 are formed corresponding to the respective pixels. The drain electrode 141, the source electrode 142, and the semiconductor film 143 of each TFT 145 are formed to have the patterns (shapes) shown in FIG. 3B, respectively.

The pixel electrode 171 and the common electrode 172, which generate a liquid-crystal driving electric field, comprise comb-tooth-like parts (i.e., thin belt-shaped parts protruding into the pixel region) 171a and 172a mated or engaged with each other, respectively. Here, the count of the comb-tooth-like parts 171a of the pixel electrode 171 is two and the count of the comb-tooth-like parts 172a of the common electrode 172 is one. As shown in FIG. 2A, the pixel electrode 171 is electrically connected to the corresponding source electrode 142 of the TFT 145 by way of the corresponding contact hole 161 that penetrates through an organic interlayer film 160 and a protective insulating film 159. The common electrode 172 is electrically connected to the corresponding common bus line 153 by way of the corresponding contact hole 162 that penetrates through the organic interlayer film 160, the protective insulating film 159, and an interlayer insulating film 157. Part of the source electrode 142 of the TFT 145 is overlapped with the corresponding common bus line 153, thereby forming a storage capacitor for the said pixel region by the said overlapped part.

The cross-sectional structure of the said prior-art LCD device is shown in FIGS. 2A and 2B, where this device is configured by coupling and unifying an active-matrix substrate and an opposite substrate to sandwich a liquid crystal between them.

The active-matrix substrate comprises a transparent glass plate 111; and the common bus lines 153, the gate bus lines 155, the drain bus lines 156, the TFTs 145, the pixel electrodes 171, and the common electrode 172, all of which are formed on or over the inner surface of the glass plate 111. The common bus lines 153 and the gate bus lines 155, which are directly formed on the inner surface of the glass plate 111, are covered with the interlayer insulating film 157. The drain electrodes 141, the source electrodes 142, and the semiconductor films 143 of the TFTs 145, and the drain bus lines 156 are formed on the interlayer insulating film 157. Thus, the common bus lines 153 and the gate bus lines 155 are electrically insulated from the drain electrodes 141, the source electrodes 142, the semiconductor films 143, and the drain bus lines 156 by the interlayer insulating film 157. These structures formed on the glass plate 111 are covered with the protective insulating film 159 except for the regions where the contact holes 161 and 162 are formed. The level differences caused by the contact holes 161 and 162 are planarized by the organic interlayer film 160 formed on the protective insulating film 159. The pixel electrodes 171 and the common electrode 172 are formed on the organic interlayer film 160. As explained above, the pixel electrode 171 is electrically connected to the corresponding source electrode 142 by way of the corresponding contact hole 161, and the common electrode 172 is electrically connected to the corresponding common bus line 153 by way of the corresponding contact hole 162. In addition, the cross-sectional views of FIGS. 2A and 2B are schematically drawn and thus, they do not reproduce the actual level differences faithfully.

The surface of the active matrix substrate having the above-described structure, on which the pixel electrodes 171 and the common electrode 172 are formed, is covered with an alignment film 131 formed by an organic polymer film. The surface of the alignment film 131 has been subjected to an alignment treatment for directing the initial orientation direction of the liquid crystal molecules 121 to a desired direction (see the arrow in FIG. 1).

On the other hand, the opposite substrate (i.e., the color filter substrate) comprises a transparent glass plate 112; and a color filter (not shown) including the three primary colors of red (R), green (G) and blue (B) formed corresponding to the respective pixel regions, and a light-shielding black matrix (not shown) formed in the regions other than those corresponding to the respective pixel regions. The color filter and the black matrix, which are formed on the inner surface of the glass plate 112, are covered with an acrylic-based overcoat film (not shown). On the inner surface of the overcoat film, columnar spacers (not shown) are formed to control the interval between the active-matrix substrate and the opposite substrate. The inner surface of the overcoat film is covered with an alignment film 132 formed by an organic polymer film. The surface of the alignment film 132 has been subjected to an alignment treatment for directing the initial orientation direction of the liquid crystal molecules 121 to a desired direction (see the arrow in FIG. 1).

The active-matrix substrate and the opposite substrate each having the above-described structure are superposed on each other at a predetermined interval in such a way that their surfaces on which the alignment films 131 and 132 are respectively formed are directed inward and opposed to each other. A liquid crystal 120 is introduced into the gap between these two substrates. The peripheries of the substrates are sealed by a sealing member (not shown) to confine the liquid crystal 120 therein. A pair of polarizer plates (not shown) is arranged on the outer surfaces of the said substrates, respectively.

The surfaces of the alignment films 131 and 132 have been uniformly alignment-treated in such a way that the liquid crystal molecules 121 are aligned in parallel along the desired direction when no electric field is applied, as described above. The alignment direction by the alignment treatments is a direction inclined clockwise by 15° with respect to the direction along which the comb-tooth-like parts 171a and 172a of the pixel and common electrodes 171 and 172 are extended (i.e., the vertical direction in FIG. 1).

The transmission axes of the pair of polarizer plates are crossed at right angles. The transmission axis of one of the pair of polarizer plates is in accordance with the initial alignment direction of the liquid crystal molecules 121 determined by the uniform alignment treatment.

Next, the fabrication process steps of the prior-art LCD device shown in FIGS. 1, 2A, and 2B will be explained below with reference to FIGS. 3A and 3B and FIGS. 4A and 4B.

The active-matrix substrate is fabricated in the following way. First, a chromium (Cr) film is formed on one of the surfaces of the glass plate 111 and patterned, thereby forming the common bus lines 153 and the gate bus lines 155 having the shapes of FIG. 3A. Thereafter, the interlayer insulating film 157, which is formed by a silicon nitride (SiNₓ) film, is formed to cover the common bus lines 153 and the gate bus lines 155 over the whole surface of the glass plate 111. Subsequently, the semiconductor films 143 (which are usually formed by an amorphous silicon (a-Si) film) are formed to have island-shaped patterns on the interlayer insulating film 157 in such a way as to be overlapped with the corresponding gate bus lines 155 by way of the interlayer insulating film 157. A Cr film is then formed on the interlayer insulating film 157 and patterned, thereby forming the drain bus lines 156, the drain electrodes 141 and the source electrodes 142 (see FIG. 3B). Thereafter, the protective insulating film 159 made of SiNₓ and the organic interlayer film 160 made of photosensitive acrylic resin are successively stacked on the interlayer insulating film 157 in this order to cover these structures. Following this, the rectangular contact holes 161 penetrating through the protective insulating film 159 and the organic interlayer film 160 and the rectangular contact holes 162 penetrating through the interlayer insulating film 157, the protective insulating film 159, and the organic interlayer film 160 are formed (see FIG. 4A). An ITO (Indium Tin Oxide) film, which is a transparent conductive material, is formed on the organic interlayer film 160 and patterned, thereby forming the pixel electrodes 171 and the common electrode 172 on the organic interlayer film 160. The pixel electrodes 171 are in contact with the corresponding source electrodes 142 by way of the corresponding contact holes 161. The common electrode 172 is in contact with the common bus lines 153 by way of the corresponding contact holes 162 (see FIGS. 4B and 2A). In this way, the active-matrix substrate is fabricated.

The opposite substrate (the color filer substrate) is fabricated in the following way. First, the color filter (not shown) and the light-shielding black matrix (not shown) are formed on one of the surfaces of the glass plate 112 and thereafter, the overcoat film (not shown) is formed to cover the color filter and the black matrix over the whole surface of the glass plate 112. Then, the columnar spacers (not shown) are formed on the overcoat film. In this way, the opposite substrate is fabricated.

The alignment films 131 and 132, which are made of polyimide, are formed on the surface of the active-matrix substrate and the surface of the opposite substrate fabricated as described above, respectively. Next, the surfaces of the alignment films 131 and 132 are uniformly alignment-treated. These two substrates are then superposed to have a constant, interval (e.g., approximately 4.5 μm), and the peripheries of the coupled substrates are sealed by the sealing member except for an injection hole for the liquid crystal. Next, in a vacuum chamber, a predetermined nematic liquid crystal (e.g., a nematic liquid crystal whose refractive index anisotropy is 0.067) is injected into the gap between the substrates through the injection hole and then, the injection hole is closed. After the substrates are coupled and unified in this way, the polarizer plates (not shown) are respectively adhered on the outer surfaces of the substrates. As a result, the prior-art LCD device having the structure shown in FIGS. 1, 2A and 2B is completed.

With the prior-art lateral electric field type LCD device described above, it is known that the liquid crystal molecules 121 are rotated to the direction opposite to the ordinary rotation direction in some regions (which are termed “reverse rotation domains”) when the liquid-crystal driving electric field is applied. If such the reverse rotation domains are generated, there is the possibility that some problems, such as the display uniformity degradation in the overall LCD device and the image burn-in due to long time operation, will arise from the viewpoint of image quality and reliability. Therefore, the reverse rotation domains need to be prevented from occurring.

A structure for preventing the reverse rotation domain (i.e., the reverse-rotation domain preventing structure) is disclosed in the above-described Publication No. 2002-323706. However, in addition to this structure, other structures are disclosed in the Japanese Unexamined Patent Publication No. 10-26767 published in 1998 and the Japanese Unexamined Patent Publication No. 2000-330123 published in 2000.

The reverse-rotation domain preventing structure disclosed in the Japanese Unexamined Patent Publication No. 2002-323706 is realized by patterning the pixel auxiliary electrodes and the common auxiliary electrodes to have slant edges in their insides, as described in the paragraphs 0247 to 0256 and FIG. 19. In other words, the edges of the pixel auxiliary electrodes and the common auxiliary electrodes on the central sides of the respective pixel regions are protruded to be sawtooth-shaped, thereby forming respectively the inclined edges with respect to the drain bus lines on the pixel auxiliary electrodes and the common auxiliary electrodes.

The reverse-rotation domain preventing structure disclosed in the Japanese Unexamined Patent Publication No. 10-26767 is shown in its claims 1 to 8 and FIGS. 1 to 6, as follows. Specifically, the initial alignment direction of the liquid crystal molecules and the direction of the liquid-crystal driving electric field are respectively maintained in predetermined ranges within the entire sub-pixel region or regions sandwiched by the parallel electrode pair in each pixel, with respect to the direction perpendicular to the running direction of the parallel electrode pair.

The reverse-rotation domain preventing structure disclosed in the Japanese Unexamined Patent Publication No. 2000-330123 is shown in its claims 1 to 3, FIGS. 1 to 5, and the first and second embodiments, as follows. Specifically, a bent part or parts, which is/are bent toward the opposite direction to the alignment direction of the liquid crystal molecules with respect to the image signal lines, is/are formed at the end(s) of at least one of the pixel electrode and the opposite electrode. Moreover, it is said that the bent part(s) is/are preferably formed at the end(s) of the comb-tooth-like pixel electrode or the comb-tooth-like opposite electrode or both.

FIG. 5 is a diagram schematically showing the generation principle of the reverse rotation domain in the prior-art LCD device shown in FIGS. 1 to 4B. To facilitate the explanation, only the pixel electrode 171, the common electrode 172 and the liquid crystal molecules 121 are shown in FIG. 5. In FIG. 5, the liquid-crystal driving electric field (its electric lines of force), which is generated by the comb-tooth-like parts 171a of the pixel electrode 171 and the comb-tooth-like part 172a of the common electrode 172, is schematically illustrated.

The rotation direction of the liquid crystal molecules 121 (the rotation of the molecules 121 is caused in planes approximately parallel to the active-matrix substrate and the opposite substrate) is defined by the relationship between the initial alignment direction of the molecules 121 and the direction of the liquid-crystal driving electric field. Therefore, the rotation direction of the molecules 121 is “clockwise” in almost all the said pixel region. However, in the vicinities of the comb-tooth-like parts 171a of the pixel electrode 171, the liquid-crystal driving electric field is radial, as shown in FIG. 5. Thus, the molecules 121 are rotated “counterclockwise” in the shadowed regions in said figure. This means that the shadowed regions are the reverse rotation domains DM where the molecules 121 are rotated “counterclockwise”.

FIG. 6 is a diagram schematically showing the principle of restraining the generation of the reverse rotation domain DM when the reverse-rotation domain preventing structure disclosed in the above-described Publication No. 2000-330123 is adopted. The reverse-rotation domain preventing structure in FIG. 6 is that bent parts 171b are formed at the respective ends of the comb-tooth-like parts 171a of the pixel electrode 171. The bent parts 171b are bent toward the opposite direction to the initial alignment direction (i.e., the alignment treatment direction) of the liquid crystal molecules with respect to the running direction of the comb-tooth-like parts 171a. Due to the existence of the bent parts 171b, the direction of the liquid-crystal driving electric field in the vicinities of the ends of the comb-tooth-like parts 171a is changed to the state shown by broken lines in FIG. 6. This means that the ranges where the liquid-crystal driving electric field is radial are reduced. As a result, the generation of the reverse rotation domain DM is restrained.

In the above-described Publication No. 2000-330123. In addition to the structure that the bent parts 171b are formed in the vicinities of the ends of the comb-tooth-like parts 171a shown in FIG. 6, another reverse-rotation domain preventing structure shown in FIG. 7 is disclosed (see claims 8 to 10, FIGS. 6 to 9 and the third to fifth embodiments). The structure of FIG. 7 is that thin belt-shaped conductors 180 are provided in the vicinities of the ends of the comb-tooth-like parts 171a of the pixel electrode 171 in such a way that an insulating film (not shown) intervenes between the ends of the parts 171a and the conductors 180. The conductors 180 comprise slant sides inclined with respect to the running direction of the comb-tooth-like parts 171a toward the opposite direction to the initial alignment direction of the liquid crystal molecules. Since the conductors 180 are electrically isolated from not only the pixel electrodes 171 and the common electrode 172 but also the other electrodes, they may be termed “floating electrodes” also.

Furthermore, the Japanese Unexamined Patent Publication No. 10-307295 published in 1998 discloses a technique that the electrodes for generating lateral electric field are bent to intentionally make the driving (rotating) direction of the liquid crystal molecules different in the respective regions with the said bent parts of the electrodes, thereby reducing the display coloring in the slant views (see claim 1, 3 and 5, and FIGS. 1, 2, 4 and 6).

For example, the following structure is taken. Specifically, the initial alignment direction of the liquid crystal molecules in the first subregion is equalized to that in the second subregion. When a voltage is applied, the liquid crystal molecules in the first and second subregions are rotated in opposite directions to each other while keeping the alignment directions of the liquid crystal molecules symmetrically in the first and second subregions (see claim 3). With this structure, preferably, the lateral electric field for driving the liquid crystal molecules is generated by the parallel electrode pair, and the electrodes constituting the parallel electrode pairs are bent into a V shape (see claim 5).

According to the study result by the inventors of the present invention, with the reverse-rotation domain preventing structure shown in FIG. 7 using the floating electrodes 180, it has been found that the generation of the reverse rotation domain is not fully restrained. The reason is as follows.

With the reverse-rotation domain preventing structure of FIG. 7, the floating electrodes 180, which are made of electrically isolated conductors by an insulating film (not shown), are provided in the vicinities of the ends of the comb-tooth-like parts 171a of the pixel electrode 171. Therefore, when a voltage is applied between the pixel electrode 171 and the common electrode 172 to generate a liquid-crystal driving electric field, the electric potential of each floating electrode 180 is determined at a predetermined value by a capacitance formed by the pixel electrode 170, the floating electrode 180, and the insulating film intervening between the electrodes 170 and 180, and another capacitance formed by the common electrode 172, the floating electrode 180, and the insulating film intervening between the electrodes 172 and 180. The qualitative appearance of the resultant liquid-crystal driving electric field (its electric lines of force) is shown by broken lines in FIG. 8.

As seen from the relationship between the direction of the electric lines and the initial alignment direction of the liquid crystal molecules shown in FIG. 8, a torque that rotates the liquid crystal molecules to the opposite direction (i.e., counterclockwise) to the normal rotation direction is applied to the liquid crystal molecules in the shadowed regions in FIG. 8. This means that even if the reverse-rotation domain preventing structure of FIG. 7 is adopted, the generation of the reverse rotation domain DM is not restrained in the vicinities of the ends of the comb-tooth-like parts 171a of the pixel electrode 171.

### SUMMARY OF THE INVENTION

The present invention was created in consideration of the above-described point and Its object is to provide a lateral electric field type LCD device that makes it sure to prevent the generation of the reverse rotation domain when the reverse-rotation domain preventing structure using the floating electrodes is adopted.

Another object of the present invention is to provide a lateral electric field type LCD device having improved image quality and improved reliability.

The above objects together with others not specifically mentioned will become clear to those skilled in the art from the following description.

A lateral electric field type LCD device according to the present invention comprises:

a first substrate and a second substrate arranged to be opposite to each other at an approximately constant interval:

a liquid crystal arranged between the first and second substrates; and

a first liquid-crystal driving electrode and a second liquid-crystal driving electrode, which are formed on one of the first and second substrates;

wherein an alignment direction of molecules of the liquid crystal is rotated in planes approximately parallel to the first and second substrates to display images by applying a liquid-crystal driving electric field approximately parallel to the first and second substrates to the liquid crystal using the first and second liquid-crystal driving electrodes;

the first and second liquid-crystal driving electrodes comprise comb-tooth-like parts extending approximately parallel to each other and being meshed or engaged with each other, respectively, in a region where images are displayed by applying the liquid-crystal driving electric field to the liquid crystal;

an electrically isolated first floating electrode is provided in a vicinity of a top end of the comb-tooth-like part of the first liquid-crystal driving electrode, where the first floating electrode comprises an overlapped part which is overlapped with the top end by way of an insulating film; and

a capacitance intervening between the first floating electrode and the first liquid-crystal driving electrode is greater than a capacitance intervening between the first floating electrode and the second liquid-crystal driving electrode.

With the lateral electric field type LCD device according to the present invention, as described above, the electrically isolated first floating electrode is provided in the vicinity of the top end of the comb-tooth-like part of the first liquid-crystal driving electrode (e.g., the pixel electrode), and the first floating electrode comprises the overlapped part which is overlapped with the top end by way of the insulating film. Moreover, the capacitance intervening between the first floating electrode and the first liquid-crystal driving electrode is greater than the capacitance intervening between the first floating electrode and the second liquid-crystal driving electrode. Therefore, when a voltage is applied between the first and second liquid-crystal driving electrodes to generate the liquid-crystal driving electric field and exert the electric field on the liquid crystal, the electric potential of the first floating electrode is closer to the electric potential of the first liquid-crystal driving electrode than the electric potential of the second liquid-crystal driving electrode. This means that the electric lines of force in the vicinity of the first floating electrode are similar to the electric lines of force obtained in the case where the prior-art reverse-rotation domain preventing structure shown in FIG. 6 is adopted.

Accordingly, even in the vicinity of the top end of the first liquid-crystal driving electrode, the rotating direction of the liquid crystal molecules due to the action of the liquid-crystal driving electric field can be controlled in such a way as to accord with the ordinary rotating direction (i.e., the normal rotating direction). As a result, in the lateral electric field type LCD device including the reverse-rotation domain preventing structure using the first floating electrode, the generation of the reverse rotation domain can be surely prevented in the vicinity of the top end of the first liquid-crystal driving electrode.

Moreover, since the generation of the reverse rotation domain can be surely prevented in the above-described manner, a LCD device having improved image quality and improved reliability compared with the prior-art LCD device is obtainable.

In a preferred embodiment of the device according to the present invention, supposing that the first floating electrode and the comb-tooth-like part of the first liquid-crystal driving electrode overlapped therewith are unified, the first floating electrode and the comb-tooth-like part of the first liquid-crystal driving electrode assume an approximately L-like bent shape; and

a rotation direction obtained by tracing the bent shape from the top end of the first floating electrode to the comb-tooth-like part of the first liquid-crystal driving electrode by way of the overlapped part is in accordance with a normal rotation direction of the molecules of the liquid crystal.

In this embodiment, there is an advantage that the effects of the present invention are obtainable more surely.

In another preferred embodiment of the device according to the present invention, an electrically isolated second floating electrode is additionally provided in a vicinity of a bottom end of the comb-tooth-like part of the second liquid-crystal driving electrode (e.g., the common electrode);

wherein the second floating electrode comprises an overlapped part which is overlapped with the bottom end by way of an insulating film; and

a capacitance intervening between the second floating electrode and the second liquid-crystal driving electrode is greater than a capacitance intervening between the second floating electrode and the first liquid-crystal driving electrode.

In this embodiment, the electrically isolated second floating electrode is additionally provided in the vicinity of the bottom end of the comb-tooth-like part of the second liquid-crystal driving electrode. Thus, when a voltage is applied between the first and second liquid-crystal driving electrodes to generate the liquid-crystal driving electric field and exert the electric field on the liquid crystal, the electric potential of the second floating electrode is closer to the electric potential of the second liquid-crystal driving electrode than the electric potential of the first liquid-crystal driving electrode. Therefore, even in the vicinity of the bottom end of the second liquid-crystal driving electrode, the rotating direction of the liquid crystal molecules due to the action of the liquid-crystal driving electric field can be controlled in such a way as to accord with the ordinary rotating direction (i.e., the normal rotating direction). As a result, there is an advantage that the image quality and reliability is improved furthermore.

In this embodiment, it is preferred that the second floating electrode is located on a different layer from that of the first floating electrode. In this case, there is an additional advantage that the capacitance intervening between the first floating electrode and the first liquid-crystal driving electrode can be made easily greater than the capacitance intervening between the first floating electrode and the second liquid-crystal driving electrode according to the presence or absence of the insulating film.

In still another preferred embodiment of the device according to the present invention, an electrically isolated third floating electrode is additionally provided in a vicinity of a top end of the comb-tooth-like part of the second liquid-crystal driving electrode (e.g., the common electrode);

wherein the third floating electrode comprises an overlapped part which is overlapped with the top end by way of an insulating film; and

a capacitance intervening between the third floating electrode and the second liquid-crystal driving electrode is greater than a capacitance intervening between the third floating electrode and the first liquid-crystal driving electrode.

In this embodiment, the electrically isolated third floating electrode is additionally provided in the vicinity of the top end of the comb-tooth-like part of the second liquid-crystal driving electrode. Thus, even in the vicinity of the top end of the second liquid-crystal driving electrode, the rotating direction of the liquid crystal molecules due to the action of the liquid-crystal driving electric field can be controlled in such a way as to accord with the ordinary rotating direction (i.e., the normal rotating direction). Accordingly, the generation of the reverse rotation domain is surely prevented in the vicinity of the top end of the second liquid-crystal driving electrode also and as a result, there is an advantage that the image quality and reliability is improved furthermore.

In a further preferred embodiment of the device according to the present invention, an electrically isolated fourth floating electrode is additionally provided in a vicinity of a bottom end of the comb-tooth-like part of the first liquid-crystal driving electrode (e.g., the pixel electrode);

wherein the fourth floating electrode comprises an overlapped part which is overlapped with the bottom end by way of an insulating film; and

a capacitance intervening between the fourth floating electrode and the first liquid-crystal driving electrode is greater than a capacitance intervening between the fourth floating electrode and the second liquid-crystal driving electrode.

In this embodiment, the electrically isolated fourth floating electrode is additionally provided in the vicinity of the bottom end of the comb-tooth-like part of the first liquid-crystal driving electrode. Thus, even in the vicinity of the bottom end of the first liquid-crystal driving electrode, the rotating direction of the liquid crystal molecules due to the action of the liquid-crystal driving electric field can be controlled in such a way as to accord with the ordinary rotating direction (i.e., the normal rotating direction). Accordingly, there is an advantage that the image quality and reliability is improved furthermore.

In a still further preferred embodiment of the device according to the present invention, the second liquid-crystal driving electrode (e.g., the common electrode) comprises a protruding part in a vicinity of a bottom end of the comb-tooth-like part thereof; and

the protruding part is formed by protruding the comb-tooth-like part of the second liquid-crystal driving electrode toward the comb-tooth-like part of the first liquid-crystal driving electrode.

In this embodiment, there is an advantage that even if an additional floating electrode is not provided in the vicinity of the bottom end of the comb-tooth-like part of the second liquid-crystal driving electrode, a similar effect to that obtained by providing the additional floating electrode is obtainable.

In a still further preferred embodiment of the device according to the present invention, a common bus line electrically connected to the second liquid-crystal driving electrode (e.g., the common electrode) is additionally provided;

wherein the common bus line comprises a protruding part formed to protrude toward a top end of the comb-tooth-like part of the second liquid-crystal driving electrode.

In this embodiment, there is an advantage that even if an additional floating electrode is not provided in the vicinity of the top end of the comb-tooth-like part of the second liquid-crystal driving electrode, a similar effect to that obtained by providing the additional floating electrode is obtainable.

In a still further preferred embodiment of the device according to the present invention, a source electrode of a thin-film transistor is additionally provided, the source electrode being electrically connected to the first liquid-crystal driving electrode (e.g., the pixel electrode);

wherein the source electrode comprises a protruding part formed to protrude toward a bottom end of the comb-tooth-like part of the first liquid-crystal driving electrode.

In this embodiment, there is an advantage that even if an additional floating electrode is not provided in the vicinity of the bottom end of the comb-tooth-like part of the first liquid-crystal driving electrode, a similar effect to that obtained by providing the additional floating electrode is obtainable.

In a still further preferred embodiment of the device according to the present invention, the region where images are displayed by applying the liquid-crystal driving electric field to the liquid crystal is divided by a dividing line or a borderline into a first subregion including a thin-film transistor and a second subregion not including a thin-film transistor; and

the first and second subregions are bent to have an approximately V-like shape or form.

In this embodiment, since the rotation directions of the liquid crystal molecules in the first and second subregions can be set to be different from each other, there is an advantage that the display coloring due to the change of the viewing angle can be restrained.

### BRIEF DESCRIPTION OF THE DRAWINGS

In order that the present invention may be readily carried into effect, it will now be described with reference to the accompanying drawings.

FIG. 1 is a partial plan view showing the schematic structure of a prior-art LCD device.

FIG. 2A is a partial cross-sectional view along the line IIA-IIA in FIG. 1.

FIG. 2B is a partial cross-sectional view along the line IIB-IIB in FIG. 1.

FIGS. 3A and 3B are partial plan views showing the process steps of a fabrication method of the prior-art LCD device of FIG. 1, respectively.

FIGS. 4A and 4B are partial plan views showing the process steps of the fabrication method of the prior-art LCD device of FIG. 1, respectively, which are subsequent to the steps of FIGS. 3A and 3B.

FIG. 5 is an enlarged partial plan view of the pixel electrode and the common electrode of the prior-art LCD device of FIG. 1, showing the state of the liquid-crystal driving electric field.

FIG. 6 is an enlarged partial plan view of the pixel electrode and the common electrode of another prior-art LCD device, showing the state of the liquid-crystal driving electric field.

FIG. 7 is an enlarged partial plan view of the pixel electrode and the common electrode of still another prior-art LCD device.

FIG. 8 is an enlarged partial plan view of the pixel electrode and the common electrode of the prior-art LCD device of FIG. 7, showing the state of the liquid-crystal driving electric field.

FIG. 9 is an enlarged partial plan view of the pixel electrode and the common electrode of a LCD device, showing the basic concept of the present invention.

FIG. 10 is an enlarged partial plan view of the pixel electrode and the common electrode of the LCD device according to the basic concept of the present invention, showing the state of the liquid-crystal driving electric field.

FIG. 11A is a partial plan view showing the schematic structure of a LCD device according to a first embodiment of the present invention.

FIG. 11B is a partial cross-sectional view along the line XIB-XIB in FIG. 11A.

FIGS. 12A and 12B are partial plan views showing the process steps of a fabrication method of the LCD device according to the first embodiment of the present invention, respectively.

FIGS. 13A and 13B are partial plan views showing the process steps of the fabrication method of the LCD device according to the first embodiment of the present invention, respectively, which are subsequent to the steps of FIGS. 12A and 12B.

FIG. 14 is an enlarged partial plan view of the pixel electrode and the common electrode of the LCD device according to the first embodiment of the present invention, showing the state of the liquid-crystal driving electric field.

FIG. 15 is an enlarged partial plan view showing the electrode and the common electrode of a LCD device according to a second embodiment of the present invention.

FIG. 16A is a partial plan view showing the schematic structure of a LCD device according to a third embodiment of the present invention.

FIG. 16B is a partial plan view showing the source electrode of the LCD device according to the third embodiment of the present invention.

FIG. 16C is a partial plan view showing the common bus line of the LCD device according to the third embodiment of the present invention.

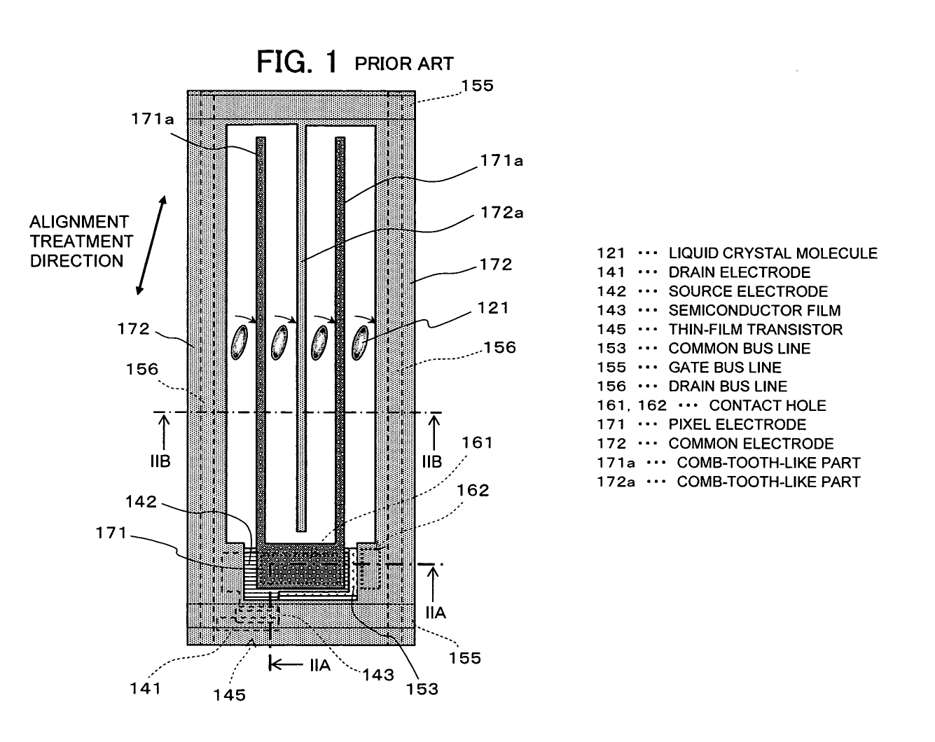

### DETAILED DESCRIPTION OF THE PREFERRED EMBODIMENTS

Preferred embodiments of the present invention will be described in detail below while referring to the drawings attached.

### Basic Concept of the Present Invention

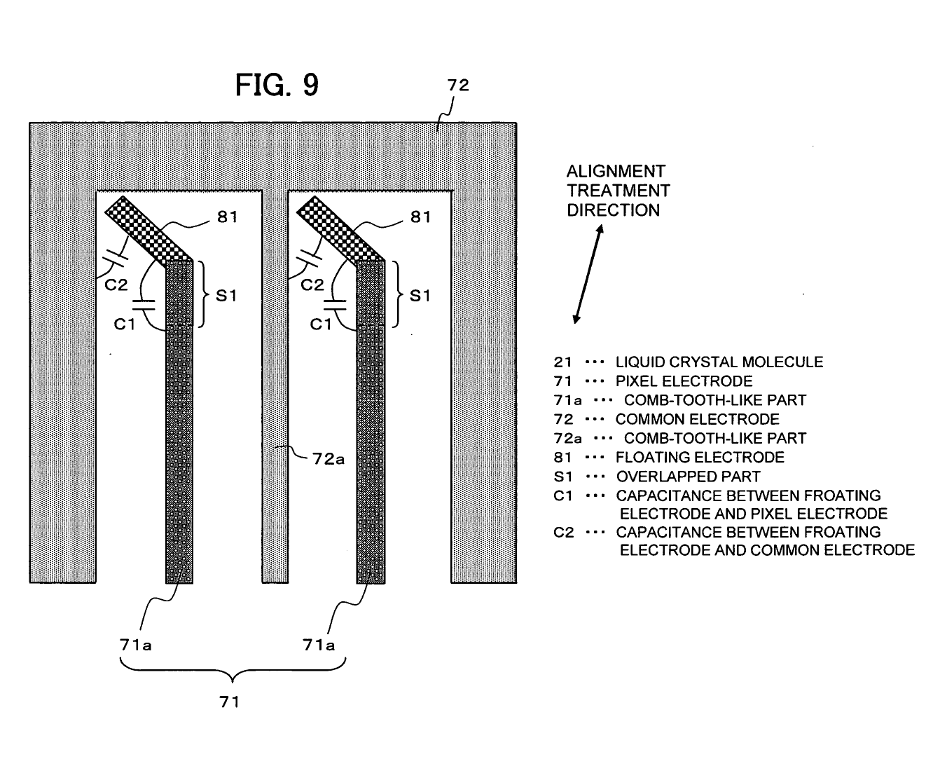

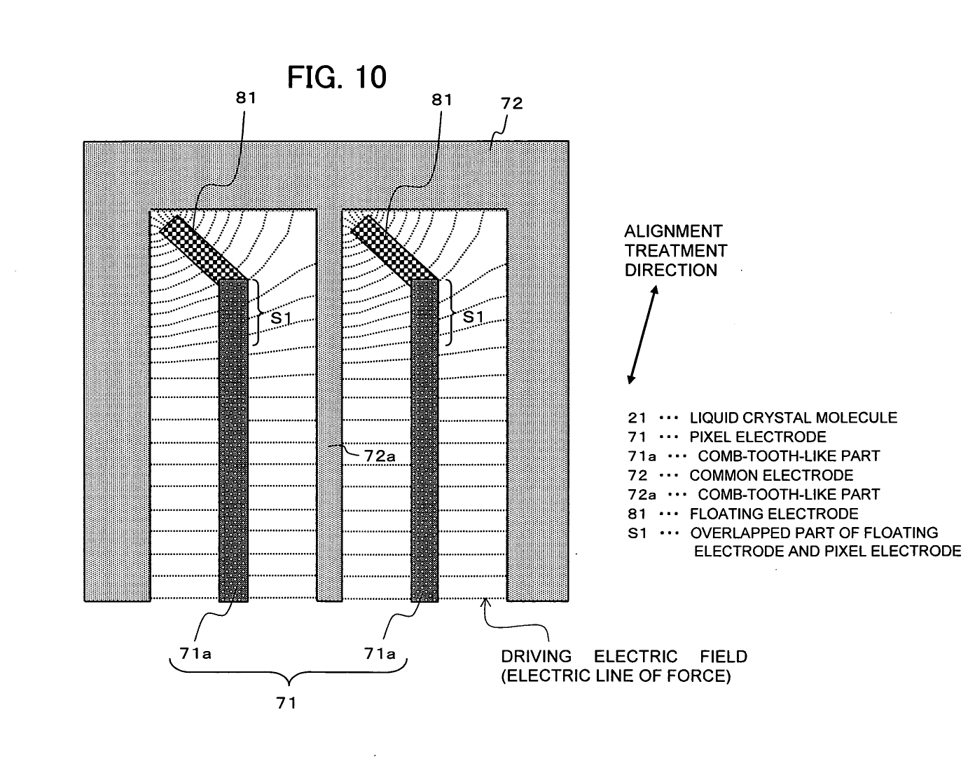

First, the basic concept of the present invention is explained below with reference to FIGS. 9 and 10. FIG. 9 is an enlarged partial plan view showing the schematic structure of the pixel electrode and the common electrode of a lateral electric field type LCD device according to the invention. FIG. 10 is an enlarged partial plan view showing the state of the liquid-crystal driving electric field (i.e., the electric lines of force) generated between the pixel and common electrodes of the said device. FIGS. 9 and 10 show the structure and the electric field in one of the pixel regions, respectively.

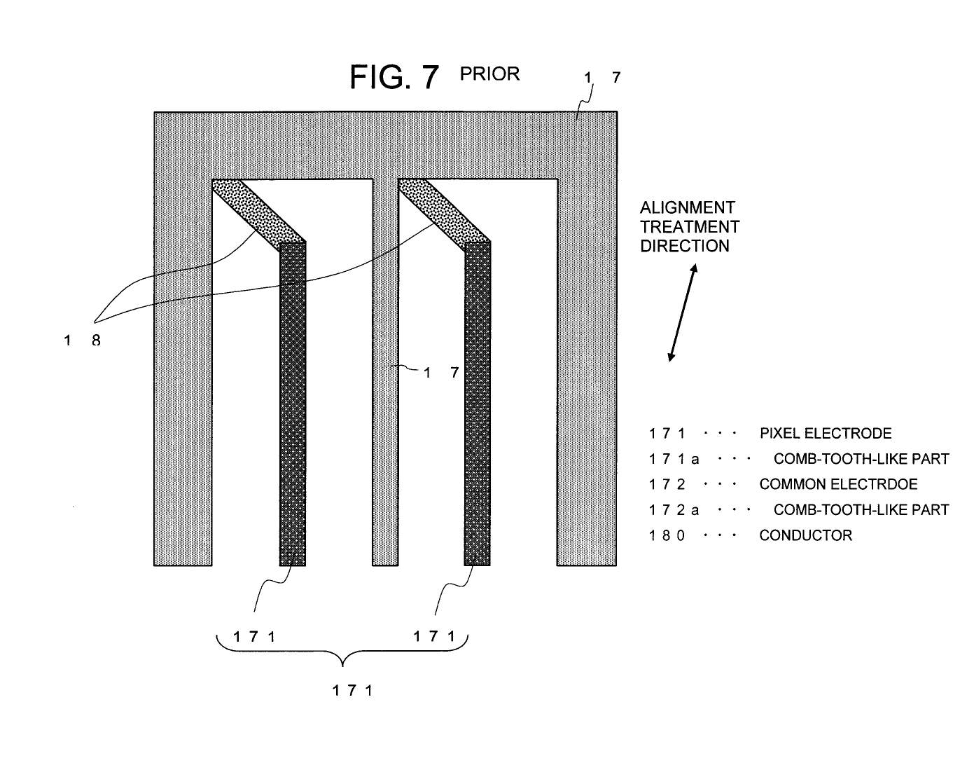

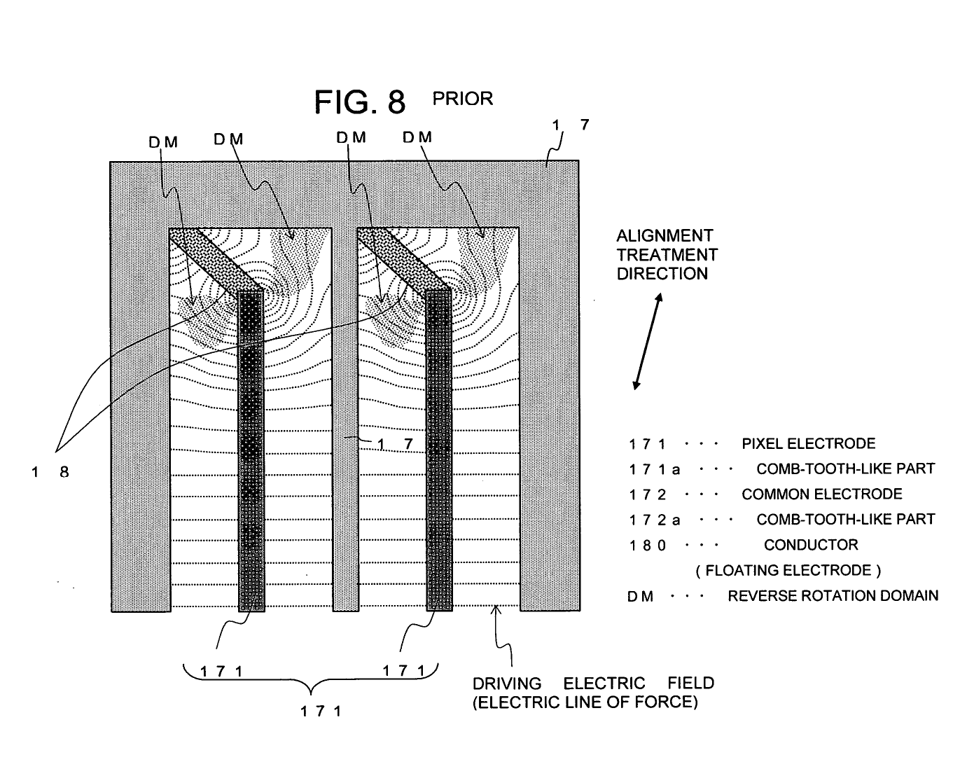

Similar to the prior-art structure shown in FIG. 7, the structure of FIG. 9 comprises a pixel electrode 71 having two comb-tooth-like parts 71a and a common electrode 72 having one comb-tooth-like parts 72a. The comb-tooth-like parts 71a and 72a are mated or engaged with each other. Each of the pixel electrode 71 and the common electrode 72 serve as a liquid-crystal driving electrode.

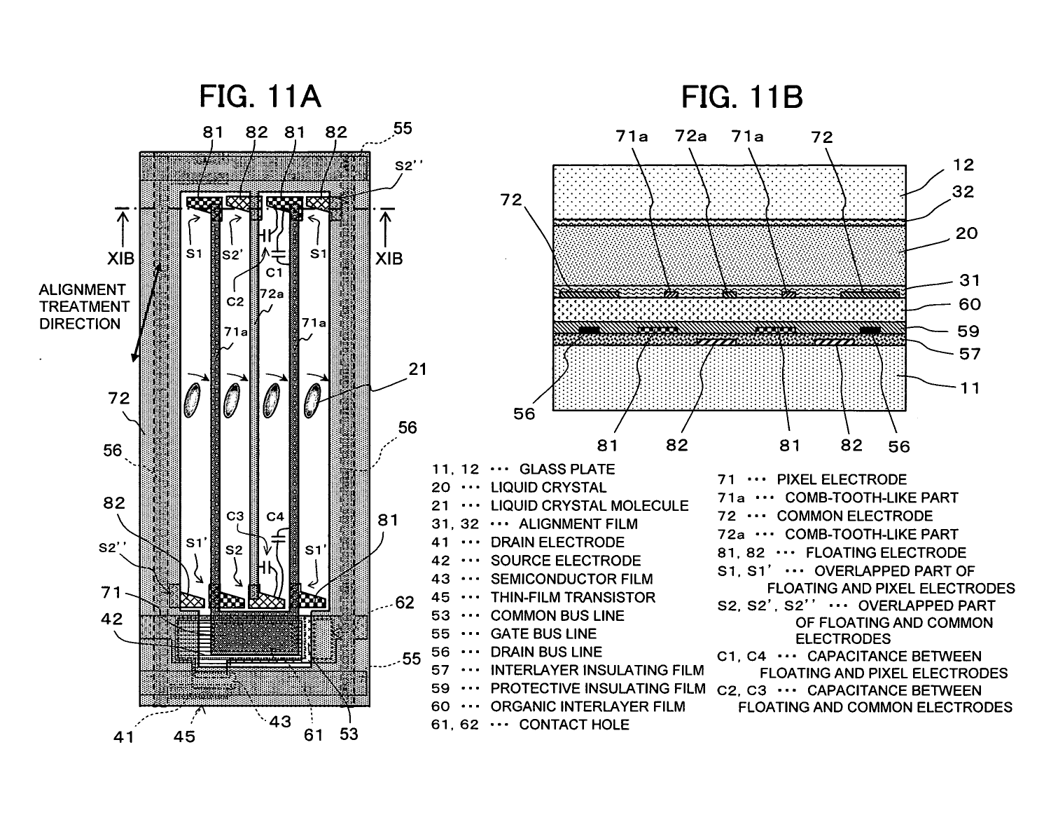

Moreover, as the reverse-rotation domain preventing structure, floating electrodes 81, each of which is made of an electrically isolated conductor, are provided in the vicinities of the top ends of the respective comb-tooth-like parts 71a of the pixel electrode 71. Each of the floating electrodes 81, which has an approximately V-like shape, comprises two arms formed by bending a thin belt. One of the arms of the electrode 81 is overlapped with the corresponding comb-tooth-like part 71a at a predetermined length from the top end of the said part 71a, forming an overlapped part Si. Here, the width of the overlapped part Si is set to be approximately equal to the width of the part 71a. The non-overlapped part of the electrode 81, which corresponds to the other arm of the said electrode 81, is inclined toward the opposite direction to the initial alignment direction (see the arrow in FIG. 9) of the liquid crystal molecules with respect to the running direction (i.e., the vertical direction in FIG. 9) of the comb-tooth-like part 71a. Each of the floating electrodes 80 is electrically insulated from the corresponding comb-tooth-like part 71a by an intervening insulating film (not shown). The intervening insulating film corresponds to the protective insulating film 59 and the organic interlayer film 60 in FIGS. 11A and 11B in the first embodiment explained later. Each of the floating electrodes 80 is electrically insulated from the common electrode 72 (and other electrodes not shown) also. Thus, each of the floating electrodes 80 is electrically isolated.

Each floating electrode 80 having the above-described structure is formed and arranged in such a way that the capacitance (the floating electrode-pixel electrode capacitance) C1 intervening between the floating electrode 80 and the comb-tooth-like part 71a of the corresponding pixel electrode 71 by way of the intervening insulating film is greater than the capacitance (the floating electrode-common electrode capacitance) C2 intervening between the floating electrode 80 and the common electrode 72. Concretely speaking, it is preferred that the floating electrode-pixel electrode capacitance C1 is twice as much as the floating electrode-common electrode capacitance C2 or greater, in consideration of the effects or advantages of the present invention. It is more preferred that the capacitance C1 is fifth times as much as the capacitance C2 or greater, and further preferred that the capacitance C1 is ten times as much as the capacitance C2 or greater.

Such the magnitude relationship as above between the capacitances C1 and C2 can be easily realized by appropriately setting the area of the overlapped part S1 between the floating electrode 81 and the corresponding pixel electrode 71 and at the same time, forming the floating electrode 81 and the corresponding pixel electrode 71 not to be overlapped or minimizing the area of the overlapped part between the floating electrode 81 and the common electrode 72. In the structure of FIG. 9, the floating electrode 81 and the common electrode 72 are formed not to have any overlapped part. In addition, since the thickness and dielectric constant of the insulating film intervening between the floating electrode 81 and the corresponding pixel electrode 71 are elements that determine the capacitances C1 and C2, it is preferred that these elements are taken into consideration. This is because a desired relationship between the capacitances C1 and C1 can be realized more easily.

FIG. 10 shows the state of the liquid-crystal driving electric field generated by applying a voltage between the pixel electrode 71 and the common electrode 72 having the structure shown in FIG. 9. In FIG. 10, the state of the electric lines of force of the liquid-crystal driving electric field is shown by broken lines. With the structure of FIG. 9, the electric potential of the floating electrode 81 under application of a voltage between the pixel electrode 71 and the common electrode 72 is determined by the ratio of the magnitude of the floating electrode-pixel electrode capacitance C1 and that of the floating electrode-common electrode capacitance C2. For example, if the magnitude of the capacitance C1 is 10 times as much as that of the capacitance C2, the electric potential of the floating electrode 81 has a value obtained by internally dividing the electric potentials of the pixel and common electrodes 71 and 72 at a ratio of 1:(10+1)=1:11. This means that the electric potential of the floating electrode 81 is extremely closer to the electric potential of the pixel electrode 71. In addition, even if the values of the capacitances C1 and C2 are varied by the change of the alignment state of the liquid crystal molecules due to the change of the applied liquid-crystal driving electric field in accordance with the image signal, the floating electrode-pixel electrode capacitance C1 is preferably kept to have a sufficiently larger value than that of the floating electrode-common electrode capacitance C2.

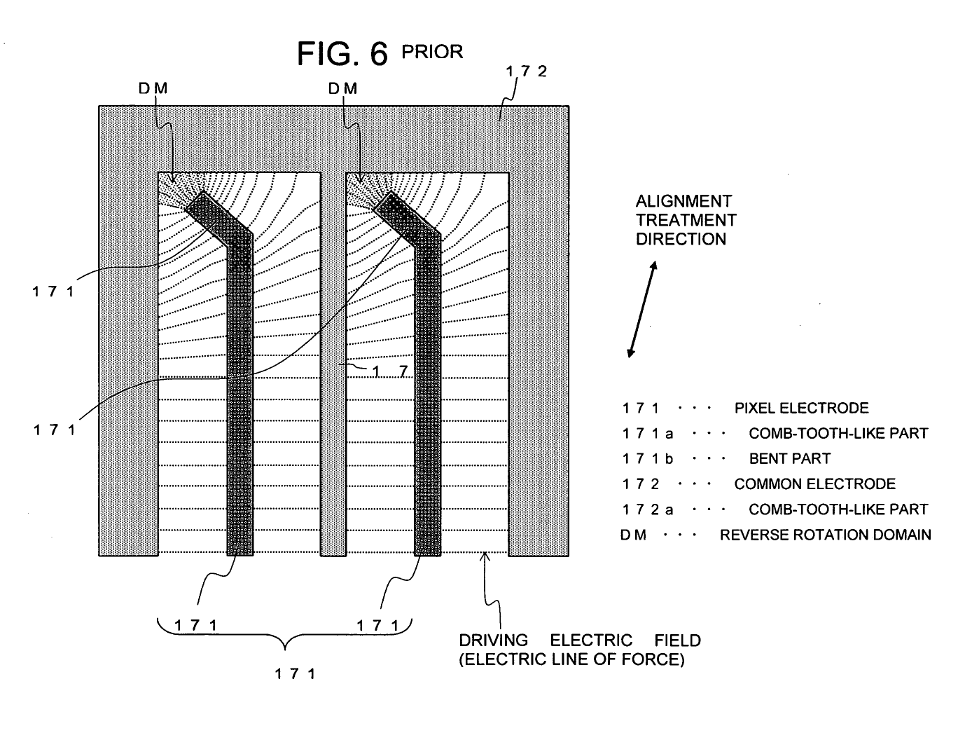

With the structure of FIG. 9, as explained above, the electric potential of the floating electrode 81 is close to the electric potential of the pixel electrode 71, which varies according to the magnitude ratio between the capacitances C1 and C2. Therefore, the liquid-crystal driving electric field in the vicinity of the top end of the floating electrode 81 is similar to that obtained in the case where the prior-art electrode structure shown in FIG. 6 is adopted (where the top end of the comb-tooth-like part 171a of each pixel electrode 171 is bent). As a result, because of the same reason as the prior-art electrode structure shown in FIG. 6, the generation of the reverse-rotation domain can be suppressed and minimized.

Moreover, with the prior-art electrode structure shown in FIG. 6, since the pixel electrode 171 and the common electrode 172 are made of the same transparent electrode material formed on the same layer, the electrodes 171 and 172 need to be apart from each other to a certain extent to avoid electrical short-circuit between them. On the other hand, with the electrode structure of the present invention shown in FIG. 9, since the floating electrodes 81 are located to be adjacent to the corresponding pixel electrodes 71 by way of the intervening insulating film, the pixel and common electrodes 71 and 72 can be made of a different electrode material from that of the floating electrodes 81, which is formed on a different layer from that of the floating electrodes 81. Accordingly, without increasing the failure possibility induced by inter-electrode short circuit, the floating electrode 81 giving an electric potential close to that of the pixel corresponding electrode 71 can be extended to the vicinity of the common electrode 72. As a result, the region where the reverse rotation domain occurs can be reduced furthermore compared with the prior-art electrode structure shown in FIG. 6. This means that uniform and stable display can be realized.

In this way, with the electrode structure of the present invention shown in FIG. 9, not only better image quality than the prior-art is obtainable but also a LCD device with an improved reliability is realizable.

Since the basic concept of the present invention is explained above, preferred embodiments of the invention will be explained below.

### First Embodiment

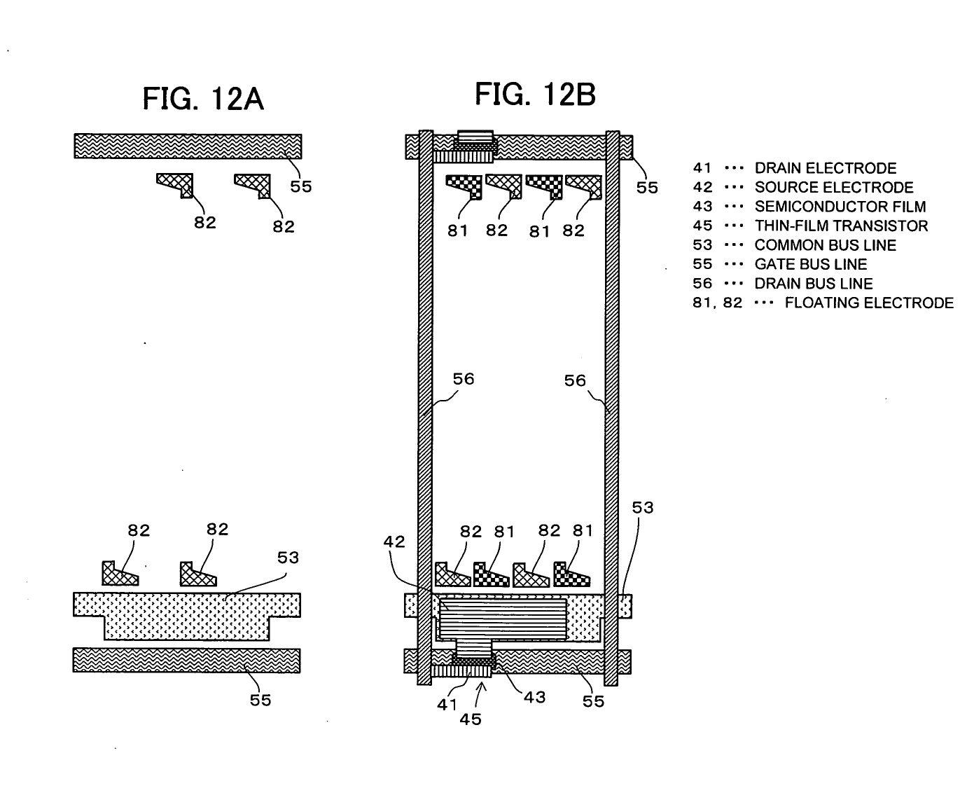

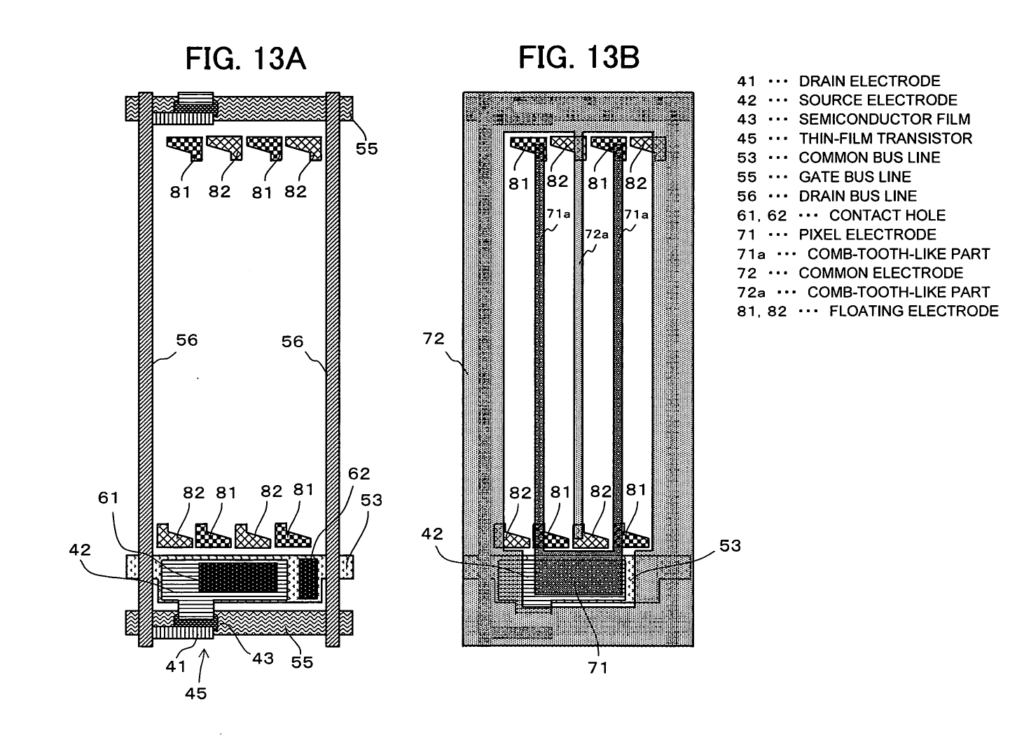

FIGS. 11A and 11B show the structure of a lateral electric field type active-matrix addressing LCD device according to a first embodiment of the present invention. FIG. 11A is a partial plan view of the device, FIG. 11B is a partial cross-sectional view along the line XIB-XIB in FIG. 11A, FIGS. 12A and 12B and FIGS. 13A and 13B are partial plan views showing the process steps of the fabrication method of the LCD device according to the first embodiment, respectively. All of these figures show the structure of one pixel region.

With this LCD device, as shown in FIGS. 11A and 12B, rectangular regions are formed by gate bus lines 55 extending along the horizontal direction of FIGS. 11A and 12B and drain bus lines 56 extending along the vertical direction thereof. Pixel regions are formed in the respective rectangular regions. Pixels (and the pixel regions) are arranged in a matrix array as a whole. Common bus lines 53 are formed to extend along the horizontal direction of FIGS. 11A and 12B, similar to the gate bus lines 55. At the respective intersections of the gate and drain bus lines 55 and 56, TFTs 45 are formed to correspond to the respective pixels. The drain electrode 41, the source electrode 42, and the semiconductor film 43 of each TFT 45 are formed to have the patterns (shapes) shown in FIG. 12B, respectively.

The pixel electrode 71 and the common electrode 72, which generate a liquid-crystal driving electric field, have the shapes or patterns shown in FIG. 11A. Specifically, the common electrode 72 comprises a frame-like main part formed to surround the said pixel region, and a comb-tooth-like part (i.e., a thin belt-shaped part protruding downward in the said pixel region) 72a extending from the middle of the upper side of the main part toward the lower side thereof in the inner space of the main part. The main part of the common electrode 72 is unified with the main parts of the common electrodes (not shown) for the other pixel regions. The lower (top) end of the comb-tooth-like part 72a is not contacted with the lower side thereof. On the other hand, the pixel electrode 71 is located in the rectangular inner space of the common electrode 72. The pixel electrode 71 comprises a rectangular plate-like main part formed to be overlapped with the source electrode 42, and two comb-tooth-like parts (i.e., two thin belt-shaped parts protruding upward in the said pixel region) 71a extending respectively from the two ends of the lower side of the main part toward the upper side thereof. These comb-tooth-like parts 71a are arranged at each side of the comb-tooth-like part 72a of the common electrode 72. Therefore, the parts 71a and 72a are laid out in such a way as to be mated or engaged with each other in the said pixel region. The intervals between the comb-tooth-like part 72a and the comb-tooth-like parts 72a at each side thereof are approximately equal to the intervals between the respective comb-tooth-like parts 71a and the main part of the common electrode 72.

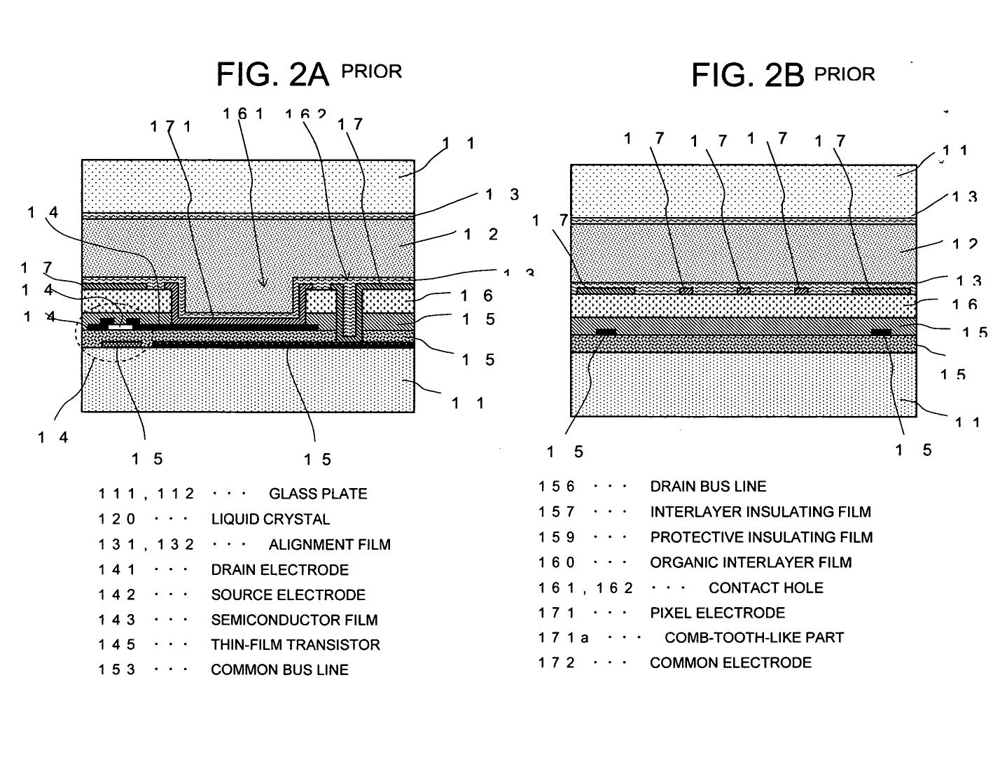

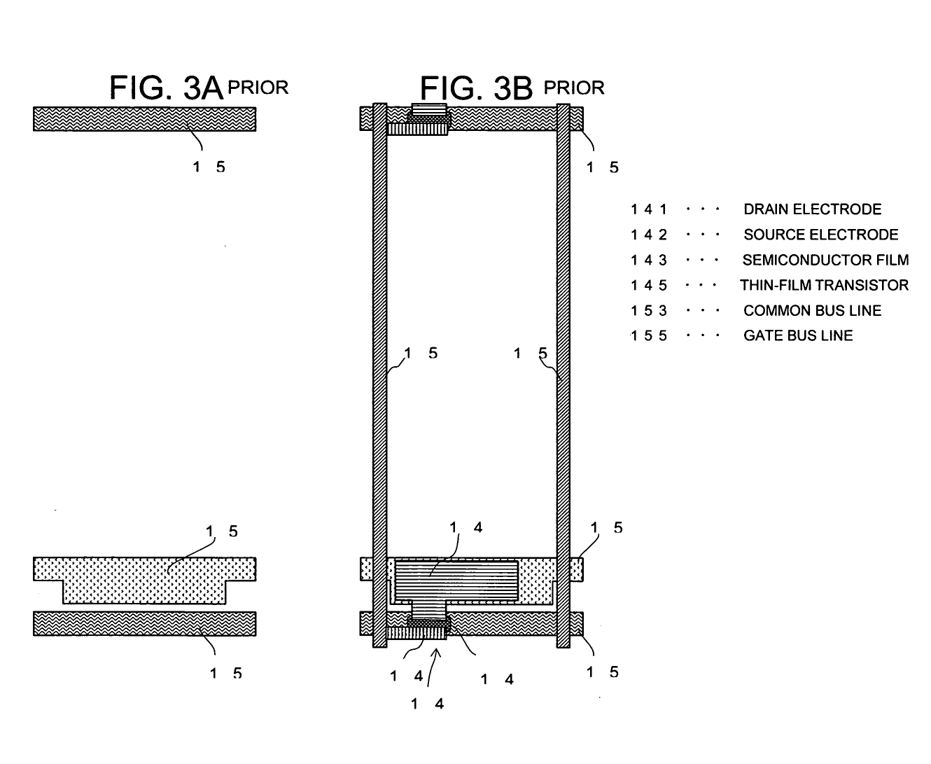

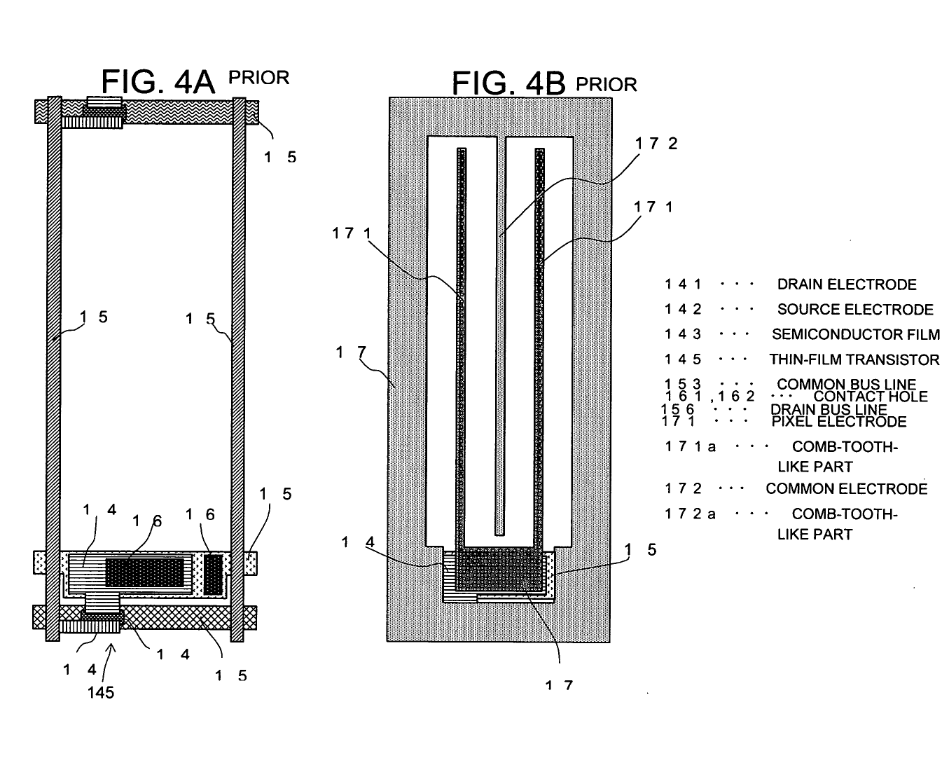

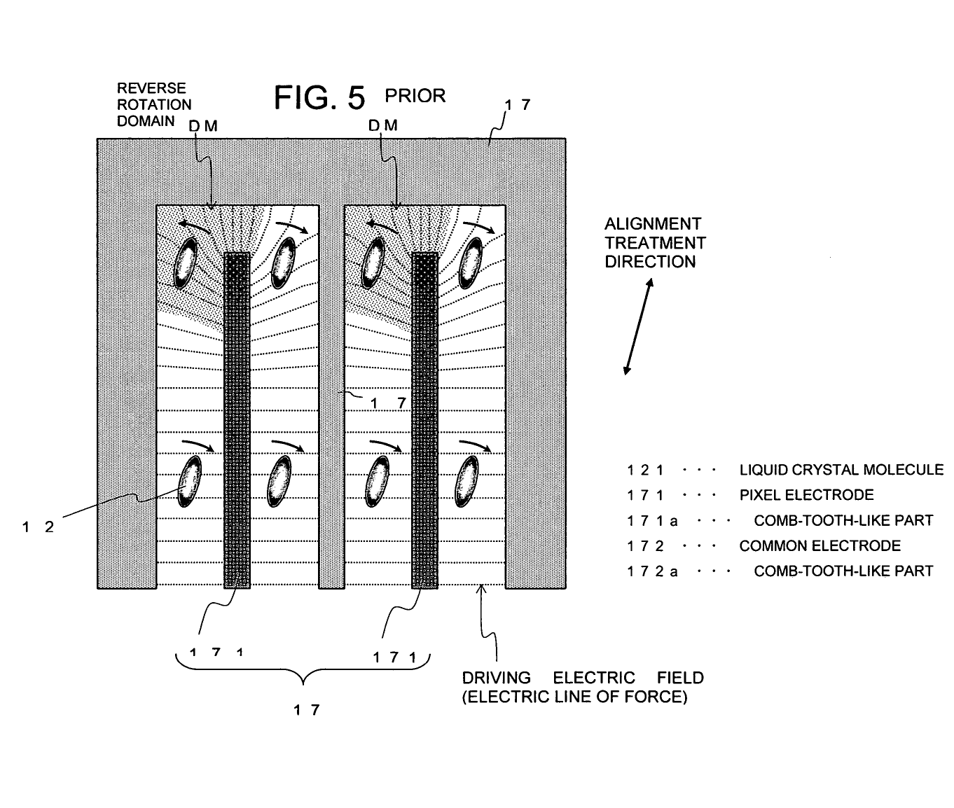

The (main part of the) pixel electrode 71 is electrically connected to the corresponding source electrode 42 of the TFT 45 by way of the corresponding contact hole 61 that penetrates through an organic interlayer film 60 and a protective insulating film 59. The (main part of the) common electrode 72 is electrically connected to the corresponding common bus line 53 by way of the corresponding contact hole 62 that penetrates through the organic interlayer film 60, the protective insulating film 59, and an interlayer insulating film 57. Their connection states are the same as those of the prior-art LCD device shown in FIG. 2A and therefore, the figure showing them is omitted here. Part of the source electrode 42 of the TFT 45 is overlapped with the corresponding common bus line 53 by way of the interlayer insulating film 57, thereby forming a storage capacitor for the said pixel region by the said overlapped part.

At the top and bottom ends of the respective comb-tooth-like parts 71a of the pixel electrode 71, electrically isolated floating electrodes 81 are provided, respectively. These floating electrodes 81 are located in a lower layer than that of the pixel electrode 71, as clearly shown in FIG. 11B, where the organic interlayer film 60 and the protective insulating film 59 intervene between the floating electrodes 81 and the pixel electrode 71. The floating electrodes 81 have an approximately L-like shape, as shown in FIG. 12B, which consists of a part extending laterally and a part extending vertically.

The vertically extending part of the floating electrode 81, which is located near the top end of the comb-tooth-like part 71a of the pixel electrode 71, is overlapped with the said part 71a almost entirely, thereby forming an overlapped part S1. The horizontally extending part of the said floating electrode 81 is not overlapped with the said part 71a. The non-overlapped part of the said floating electrode 81 protrudes horizontally to the left side from the said top end of the part 71a. The said floating electrode 81 protrudes toward the left side from the extending direction of the part 71a (i.e., the vertical direction in FIG. 11A) while setting the overlapped part S1 as the origin. As a result, supposing that the floating electrode 81 and the corresponding comb-tooth-like part 71a are unified, the floating electrode 81 and the corresponding comb-tooth-like part 71a assume an approximately L-like bent shape. Moreover, the rotation direction obtained by tracing the bent shape from the top end of the floating electrode 81 to the bottom end of the part 71a by way of the overlapped part S1 is clockwise, which is in accordance with the normal rotation direction of the liquid crystal molecules 21 (here, clockwise). See the thick arrow in FIG. 11A.

The vertically extending part of the floating electrode 81 located near the bottom end of the comb-tooth-like part 71a of the pixel electrode 71 is similar to that located near the top end of the part 71a as described above. Specifically, the vertically extending part of the floating electrode 81, which is located near the bottom end of the comb-tooth-like part 71a, is overlapped with the said part 71a, thereby forming an overlapped part S1′. The horizontally extending part of the said floating electrode 81 is not overlapped with the said part 71a. The non-overlapped part of the said floating electrode 81 protrudes-horizontally to the right side from the said bottom end of the part 71a. The said floating electrode 81 protrudes toward the right side from the extending direction of the part 71a (i.e., the vertical direction in FIG. 11A) while setting the overlapped part S1′ as the origin. As a result, supposing that the floating electrode 81 and the corresponding comb-tooth-like part 71a are unified, the floating electrode 81 and the comb-tooth-like part 71a assume an approximately L-like bent shape. Moreover, the rotation direction obtained by tracing the bent shape from the top end of the floating electrode 81 to the top end of the part 71a by way of the overlapped part S1′ is clockwise as well, which is in accordance with the normal rotation direction of the liquid crystal molecules 21.

At the top and bottom ends of the respective comb-tooth-like parts 72a of the common electrode 72, electrically isolating floating electrodes 82 are provided, respectively. These floating electrodes 82 are located in a lower layer than that of the common electrode 72, as shown in FIG. 11B, where the organic interlayer film 60, the protective insulating film 59, and the interlayer insulating film 57 intervene between the floating electrodes 82 and the common electrode 72. The floating electrodes 82 have an approximately L-like shape, as shown in FIG. 12A, which consists of a part extending laterally and a part extending vertically. Here, the shape of the floating electrodes 82 is the same as that of the floating electrodes 81.

The vertically extending part of the floating electrode 82, which is located near the top end of the comb-tooth-like part 72a of the common electrode 72, is overlapped with the said part 72a, thereby forming an overlapped part S2. The horizontally extending part of the said floating electrode 82 is not overlapped with the said part 72a. The non-overlapped part of the said floating electrode 82 protrudes horizontally to the right side from the said top end of the part 72a. The said floating electrode 82 protrudes toward the right side from the extending direction of the part 72a while setting the overlapped part S2 the origin. As a result, supposing that the floating electrode 82 and the corresponding comb-tooth-like part 72a are unified, the floating electrode 82 and the comb-tooth-like part 72a assume an approximately L-like bent shape. Moreover, the rotation direction obtained by tracing the bent shape from the top end of the floating electrode 82 to the bottom end of the part 72a by way of the overlapped part S2 is clockwise, which is in accordance with the normal rotation direction of the liquid crystal molecules 21.

The vertically extending part of the floating electrode 82 located near the bottom end of the comb-tooth-like part 72a of the common electrode 72 is similar to that located near the top end of the part 72a as described above. Specifically, the vertically extending part of the floating electrode 82, which is located near the bottom end of the comb-tooth-like part 72a, is overlapped with the said part 72a, thereby forming an overlapped part S2′. The horizontally extending part of the said floating electrode 82 is not overlapped with the said part 72a. The non-overlapped part of the said floating electrode 82 protrudes horizontally to the left side from the said top end of the part 72a. The said floating electrode 82 protrudes toward the left side from the extending direction of the part 72a while setting the overlapped part S2′ as the origin. As a result, supposing that the floating electrode 82 and the corresponding comb-tooth-like part 72a are unified, the floating electrode 82 and the comb-tooth-like part 72a assume an approximately L-like bent shape. Moreover, the rotation direction obtained by tracing the bent shape from the top end of the floating electrode 82 to the top end of the part 72a by way of the overlapped part S2′ is clockwise as well, which is in accordance with the normal rotation direction of the liquid crystal molecules 21.

At the inner positions near the upper right corner and the lower left corner of the main part of the common electrode 72 also, electrically isolating floating electrodes 82 are provided, respectively. These floating electrodes 82 are located in a lower layer than the common electrode 72, where the organic interlayer film 60, the protective insulating film 59, and the interlayer insulating film 57 intervene between the floating electrodes 82 and the common electrode 72. The floating electrodes 82 have an approximately L-like shape, as shown in FIG. 12A, which consists of a part extending laterally and a part extending vertically. Here, the shape of the floating electrodes 82 is the same as that of the above-described floating electrodes 82.

The vertically extending part of the floating electrode 82 located at the inner position near the upper right corner of the main part of the common electrode 72 is overlapped with the said main part, thereby forming an overlapped part S2′″. The horizontally extending part of the said floating electrode 82 is not overlapped with the said main part. The non-overlapped part of the said floating electrode 82 protrudes horizontally to the left side from the said main part. The said floating electrode 82 protrudes toward the left side from the extending direction of the said main part while setting the overlapped part S2″ as the origin. As a result, supposing that the said floating electrode 82 and the said main part are unified, they assume an approximately L-like bent shape. Moreover, the rotation direction obtained by tracing the bent shape from the top end of the floating electrode 82 to the bottom end of the main part by way of the overlapped part S2″ is clockwise, which is in accordance with the normal rotation direction of the liquid crystal molecules 21.

The vertically extending part of the floating electrode 82 is located at the inner position near the lower left corner of the main part of the common electrode 72 is overlapped with the said main part, thereby forming an overlapped part S2″. This is similar to the above-described vertically extending part of the floating electrode 82 located at the inner position near the upper right corner of the main part of the common electrode 72. The horizontally extending part of the said floating electrode 82 is not overlapped with the said main part. The non-overlapped part of the said floating electrode 82 protrudes horizontally to the right side from the said main part. The said floating electrode 82 protrudes toward the right side from the extending direction of the said main part while setting the overlapped part S2′″ as the origin. As a result, supposing that the said floating electrode 82 and the said main part are unified, they assume an approximately L-like bent shape. Moreover, the rotation direction obtained by tracing the bent shape from the top end of the floating electrode 82 to the bottom end of the main part by way of the overlapped part S2″ is clockwise, which is in accordance with the normal rotation direction of the liquid crystal molecules 21.

The cross-sectional structure of the LCD device according to the first embodiment is shown in FIG. 11B, where the device is configured by coupling and unifying an active-matrix substrate and an opposite substrate to sandwich a liquid crystal between them.

The active-matrix substrate comprises a transparent glass plate 11; and the common bus lines 53, the gate bus lines 55, the drain bus lines 56, the TFTs 45, the pixel electrodes 71, the common electrode 72, and the floating electrodes 81 and 82, all of which are formed on or over the Inner surface of the glass plate 11. The common bus lines 53, the gate bus lines 155, and the floating electrodes 82, which are directly formed on the inner surface of the glass plate 11, are covered with the interlayer insulating film 57. The drain electrodes 41, the source electrodes 42, and the semiconductor films 43 of the TFTs 45, the drain bus lines 56, and the floating electrodes 81 are formed on the interlayer insulating film 57. Thus, the common bus lines 53, the gate bus lines 55, and the floating electrodes 82 are electrically insulated from the drain electrodes 41, the source electrodes 42, the semiconductor films 43, the drain bus lines 56, and the floating electrodes 81 by the interlayer insulating film 57. These structures formed on the glass plate 11 are covered with the protective insulating film 59 except for the regions where the contact holes 61 and 62 are formed. The level differences caused by the contact holes 61 and 62 are planarized by the organic interlayer film 60 formed on the protective insulating film 59. The pixel electrodes 71 and the common electrode 72 are formed on the organic interlayer film 60. As explained above, the pixel electrode 71 is electrically connected to the corresponding source electrode 42 by way of the corresponding contact hole 61, and the common electrode 72 is electrically connected to the corresponding common bus line 53 by way of the corresponding contact hole 62. In addition, the cross-sectional view of FIG. 11B is schematically drawn and thus, it does not reproduce the actual level differences faithfully.

The surface of the active matrix substrate having the above-described structure, on which the pixel electrodes 71 and the common electrode 72 are formed, is covered with an alignment film 31 formed by an organic polymer film. The surface of the alignment film 31 has been subjected to an alignment treatment for directing the initial orientation direction of the liquid crystal molecules 21 to a desired direction (see the arrow in FIG. 11A).

On the other hand, the opposite substrate comprises a transparent glass plate 12; and a color filter (not shown) including the three primary colors of R, G and B, and a light-shielding black matrix (not shown) formed in the regions other than those corresponding to the respective pixel regions, both of which are formed on the Inner surface of the glass plate 12. The color filter and the black matrix are covered with an acrylic-based overcoat film (not shown). On the inner surface of the overcoat film, columnar spacers (not shown) are formed to control the interval between the active-matrix substrate and the opposite substrate. The inner surface of the overcoat film is covered with an alignment film 32 formed by an organic polymer film. The surface of the alignment film 32 has been subjected to an alignment treatment for directing the initial orientation direction of the liquid crystal molecules 21 to a desired direction (see the arrow in FIG. 11A).

The active-matrix substrate and the opposite substrate each having the above-described structure are superposed on each other at a predetermined interval in such a way that their surfaces on which the alignment films 31 and 32 are directed inward and opposed to each other. A liquid crystal 20 is introduced into the gap between the both substrates. The peripheries of the substrates are sealed by a sealing member (not shown) to confine the liquid crystal 20 therein. A pair of polarizer plates is arranged on the outer surfaces of the substrates, respectively.

The surfaces of the alignment films 31 and 32 are uniformly alignment-treated in such a way that the liquid crystal molecules 21 are aligned along the desired direction when no electric field is applied, as described above. The alignment direction by the alignment treatments is a direction inclined clockwise by 15° with respect to the direction along which the comb-tooth parts 71a and 72a of the pixel and common electrodes 71 and 72 are extended (i.e., the vertical direction in FIG. 11A).

The transmission axes of the pair of polarizer plates are crossed at right angles. The transmission axis of one of the pair of polarizer plates is in accordance with the initial alignment direction of the liquid crystal molecules determined by the uniform alignment treatment.

Since each of the floating electrodes 81 provided for the pixel electrodes 71 is opposed to the corresponding comb-tooth-like part 71a of the pixel electrode 71 by way of the protective insulating film 59 and the organic interlayer film 60, it has a capacitance (the floating electrode-pixel electrode capacitance) C1 with respect to the pixel electrode 71. Moreover, since the said floating electrodes 81 is opposed to (the main part and the comb-tooth-like part 72a of) the corresponding common pixel electrode 72 by way of the protective insulating film 59 and the organic interlayer film 60, it has a capacitance (the floating electrode-common electrode capacitance) C2 with respect to the common electrode 72. As seen from FIG. 11B, the distance between the floating electrode 81 and the pixel electrode 71 is set to be smaller than that between the floating electrode 81 and the common electrode 72 and therefore, it is apparent that these capacitances C1 and C2 have a relationship of C1>C2. By adjusting the relationship between the areas of the overlapped parts S1 and S1′ and adjusting the thickness and/or dielectric constant of the protective insulating film 59 and the organic interlayer film 60 located between the floating electrode 81 and the pixel electrode 71, as already explained in BASIC CONCEPT OF THE PRESENT INVENTION, the value of C1 is preferably set to be twice as much as that of C2 or greater. It is more preferred that the value of C1 is five times as much as that of C2 or greater. It is still more preferred that the value of C1 is ten times as much as that of C2 or greater.

By setting the magnitude ratio of the capacitances C1 and C2 to be C1>C2, the electric potential of the floating electrode 81 can be made close to the electric potential of the pixel electrode 71. Thus, the state of the liquid-crystal driving electric field generated in the vicinity of the top end of the comb-tooth-like part 71a of the pixel electrode 71 is similar to that obtained in the case where the prior-art electrode structure of FIG. 6 is adopted (i.e., the structure that the end of the comb-tooth-like part 171a of the pixel electrode 171 is bent is adopted). Accordingly, because of the same reason as for the prior-art electrode structure, the generation of the reverse rotation domain can be effectively restrained in the vicinity of the top end of each comb-tooth-like part 71a. In addition, by setting the value of C1 is five times or ten times as much as that of C2 or greater, the generation of the reverse rotation domain can be minimized.

The above explanation for the floating electrodes 81 is applied to the floating electrodes 82 provided for the common electrode 72. Specifically, since each of the floating electrodes 82 is opposed to the corresponding comb-tooth-like part 72a or main part of the common electrode 72 by way of the interlayer insulating film 57, the protective insulating film 59, and the organic interlayer film 60, it has a capacitance (the floating electrode-common electrode capacitance) C3 with respect to the common electrode 72. Moreover, since the said floating electrodes 82 is opposed to (the main part or the comb-tooth-like part 71a of) the corresponding pixel electrode 71 by way of interlayer insulating film 57, the protective insulating film 59, and the organic interlayer film 60, it has a capacitance (the floating electrode-pixel electrode capacitance) C4 with respect to the pixel electrode 71. The capacitances C3 and C4 are set to have a relationship of C3>C4. As already explained in BASIC CONCEPT OF THE PRESENT INVENTION, it is preferred that the value of C3 is twice as much as that of C4 or greater, more preferred that the value of C3 is five times as much as that of C4 or greater, and still more preferred that the value of C3 is ten times as much as that of C4 or greater.

Such the magnitude relationship between C3 and C4 as above is realized by appropriately setting the areas of the overlapped parts S2 and S2′ and forming the floating electrode 82 not to be overlapped with the corresponding pixel electrode 71. At that time, the thickness and/or dielectric constant of the interlayer insulating film 57, the protective insulating film 59 and the organic interlayer film 60 located between the floating electrode 82 and the corresponding pixel electrode 71 in the overlapped parts S2 and S2′ also are taken into consideration.

By setting the magnitude ratio of the capacitances C3 and C4 to be C3>C4, the electric potential of the floating electrode 82 can be made close to the electric potential of the common electrode 72. Thus, the state of the liquid-crystal driving electric field generated in the vicinity of the top end of the comb-tooth-like part 72a of the common electrode 72 is similar to that obtained in the case where the prior-art electrode structure of FIG. 6 is adopted (i.e., the structure that the end of the comb-tooth-like part 171a of the pixel electrode 171 is bent is adopted). Accordingly, because of the same reason as for the prior-art electrode structure, the generation of the reverse rotation domain can be effectively restrained in the vicinity of the top end of each comb-tooth-like part 72a.

In addition, the initial alignment direction (i.e., the alignment treatment direction) of the liquid crystal molecules 21 is a direction inclined clockwise by 15° with respect to the direction along which the comb-tooth parts 71a and 72a of the pixel and common electrodes 71 and 72 are extended (i.e., the vertical direction in FIG. 11A). See the thick arrow in FIG. 11A. For this reason, when a liquid-crystal driving electric field is applied to the liquid crystal molecules 21, the molecules 21 will rotate clockwise (see the curved arrows in FIG. 11A).

Next, the fabrication process steps of the LCD device according to the first embodiment shown in FIGS. 11A and 11B will be explained below with reference to FIGS. 12A and 12B and FIGS. 13A and 13B.

The active-matrix substrate is fabricated in the following way. First, a Cr film is formed on one of the surfaces of the glass plate 111 and patterned, thereby forming the common bus lines 53, the gate bus lines 55, and the floating electrodes 82 for the common electrodes 72, each having the shapes of FIG. 12A. Thereafter, the interlayer insulating film 57, which is formed by a SiNₓ film, is formed to cover the common bus lines 53, the gate bus lines 55 and the floating electrodes 82 over the whole surface of the glass plate 11. Subsequently, the semiconductor films 43 (which are usually formed by an a-Si film) are formed to have island-shaped patterns on the interlayer insulating film 57 in such a way as to be overlapped with the corresponding gate bus lines 55 by way of the interlayer insulating film 57. A Cr film is formed on the interlayer insulating film 57 and is patterned, thereby forming the drain bus lines 56, the drain electrodes 41, the source electrodes 142, and the floating electrodes 81 for the pixel electrode 71 (see FIG. 12B). Thereafter, the protective insulating film 59 made of SiNₓ and the organic interlayer film 60 made of photosensitive acrylic resin are successively stacked on the interlayer insulating film 57 in this order. Following this, the rectangular contact holes 61 penetrating through the protective insulating film 59 and the organic interlayer film 60 and the rectangular contact holes 62 penetrating through the interlayer insulating film 57, the protective insulating film 59, and the organic interlayer film 60 are formed (see FIG. 13A). An ITO film, which is a transparent conductive material, is formed on the organic interlayer film 60 and patterned, thereby forming the pixel electrodes 71 and the common electrode 72 on the organic interlayer film 60. The pixel electrodes 71 are in contact with the corresponding source electrodes 42 by way of the corresponding contact holes 61. The common electrode 72 is in contact with the common bus lines 53 by way of the corresponding contact holes 62). In this way, the active-matrix substrate is fabricated.

The opposite substrate (the color filer substrate) is fabricated in the following way. First, the color filter (not shown) and the light-shielding black matrix (not shown) are formed on the glass plate 12 and thereafter, the overcoat film (not shown) is formed to cover the color filter and the black matrix over the whole surface of the glass plate 12. Then, the columnar spacers (not shown) are formed on the overcoat film. In this way, the opposite substrate is fabricated.

The alignment films 31 and 32, which are made of polyimide, are formed on the surfaces of the active-matrix substrate and the opposite substrate fabricated as described above, respectively. Next, the surfaces of the alignment films 31 and 32 are uniformly alignment-treated. These two substrates are then superposed to have a constant interval (e.g. approximately 4.5 μm), and the peripheries of the substrates are sealed by the sealing member except for an injection hole for the liquid crystal. Next, in a vacuum chamber, a predetermined nematic liquid crystal (e.g., a p-type nematic liquid crystal whose refractive index anisotropy is 0.067) is injected into the gap between the substrates through the injection hole and thereafter, the injection hole is closed. After the substrates are coupled and unified in this way, the polarizer plates (not shown) are respectively adhered on the outer surfaces of the substrates. As a result, the LCD device according to the first embodiment shown in FIGS. 11A and 11B is completed.

An n-type nematic liquid crystal may be used. In this case, it is sufficient that only the alignment direction is made different by 90° with respect to the above-described angle while keeping the other elements the same. In the following explanation, a p-type is nematic liquid crystal is used.

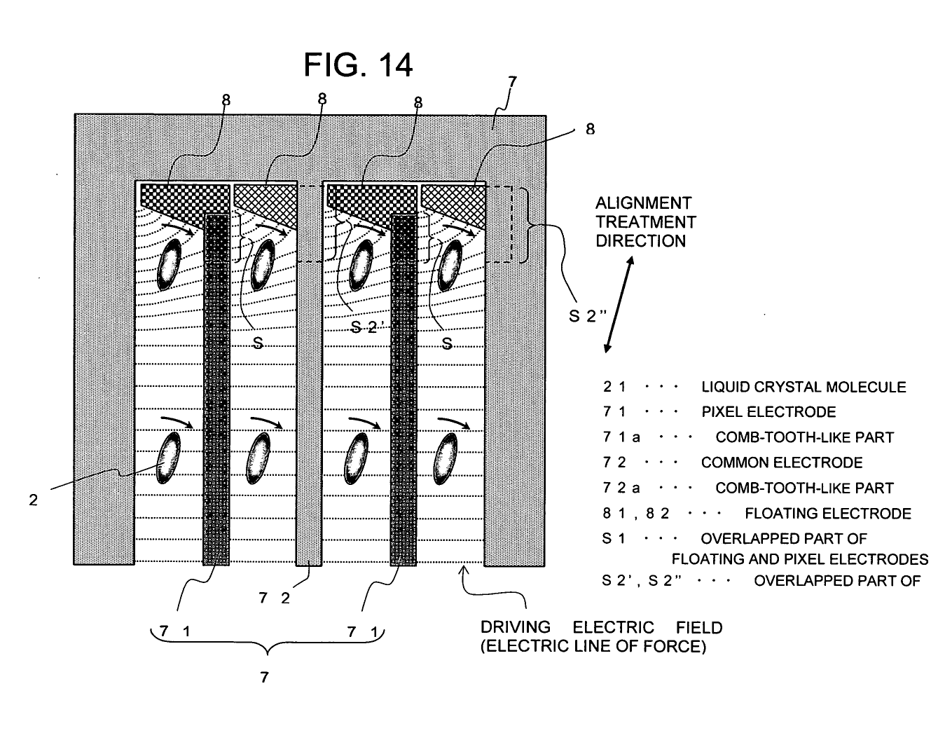

Next, the operation of the LCD device according to the first embodiment will be explained below with reference to FIG. 14. In FIG. 14, the state of the liquid-crystal driving electric field generated by applying a voltage between the pixel electrode 71 and the common electrode 72 is shown by broken lines that denote the electrical lines of force of the electric field. The rotation direction of the liquid crystal molecules 21 due to the action of the liquid-crystal driving electric field is shown by curved arrows, also.

As described previously, the initial alignment direction of the liquid crystal molecules 21 is a direction inclined clockwise by 159 with respect to the direction along which the comb-tooth parts 71a and 72a of the pixel and common electrodes 71 and 72 are extended (i.e., the vertical direction in FIG. 11A). Therefore, when the liquid-crystal driving electric field is applied, the molecules 21 are rotated clockwise in the ordinary regions. Moreover, as shown in FIG. 11, because the floating electrodes 81 and 82 are respectively provided, the liquid-crystal driving electric field is inclined along the same direction in the vicinities of the top end of the comb-tooth-like part 71a of each pixel electrode 71 and the bottom end of the comb-tooth-like part 72a of each common electrode 72. Thus, the molecules 21 are rotated clockwise similar to the ordinary regions, which means that the reverse rotation domain is refrained from being generated. As a result, not only improved image quality is obtainable but also an LCD device having improved reliability is realizable.

In addition, although the floating electrodes 81 are provided for the pixel electrodes 71 and the floating electrodes 82 are provided for the common electrode 72 in the first embodiment, the floating electrodes 82 may be omitted, if the magnitude ratio of the capacitances C1 and C2 can be set sufficiently large. This is applicable to the second and third embodiments explained below.

### Second Embodiment

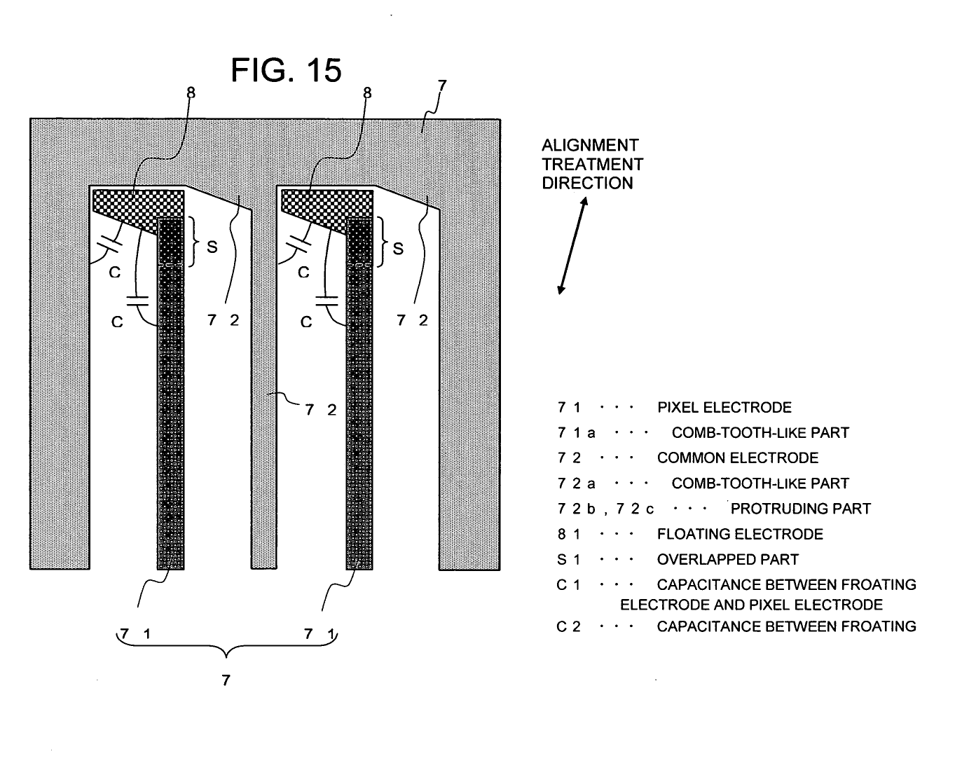

FIG. 15 is a similar drawing to FIG. 14, which shows the feature of a LCD device according to a second embodiment. The second embodiment is the same in structure as the above-described first embodiment except that the floating electrodes 82 provided near the bottom end of the comb-tooth-like part 72a of the common electrode 72 and the upper right corner of the main part of the common electrode 72 thereof are omitted, and that an inclined protruding part 72b is provided at the bottom end of the part 72a and an inclined protruding part 72c is provided at the inner side of the upper right corner thereof instead. Therefore, the explanation about the same structure is omitted by attaching the same reference symbols as used in the first embodiment to the same elements.

Although not shown in FIG. 15, the floating electrodes 82 are respectively provided near the top end of the comb-tooth-like part 72a of the common electrode 72 and the lower left corner of the main part of the common electrode 72 thereof, which is similar to the structure of the first embodiment (see FIG. 11A).

In FIG. 15, the protruding part 72b provided near the bottom end of the comb-tooth-like part 72a has a similar plan shape to the non-overlapped part (the part other than the overlapped part S2′) of the floating electrode 82 with the common electrode 72. By this structure, the electric potential of the protruding part 72b can be equalized to that of the common electrode 72.

Moreover, the protruding part 72c provided near the inner side of the upper right corner of the common electrode 72 has a similar plan shape to the non-overlapped part (the part other than the overlapped part S2″) of the floating electrode 82 with the common electrode 72. By this structure, the electric potential of the protruding part 72c can be equalized to that of the common electrode 72.

With the second embodiment, as explained above, the protruding parts 72b and 72c are provided for the common electrode 72. Therefore, an approximately the same liquid-crystal driving electric field as the first embodiment is generated, which means that the reverse rotation domain is refrained from being generated in the same way as the first embodiment. As a result, not only improved image quality is obtainable but also an LCD device having improved reliability is realizable.

### Third Embodiment

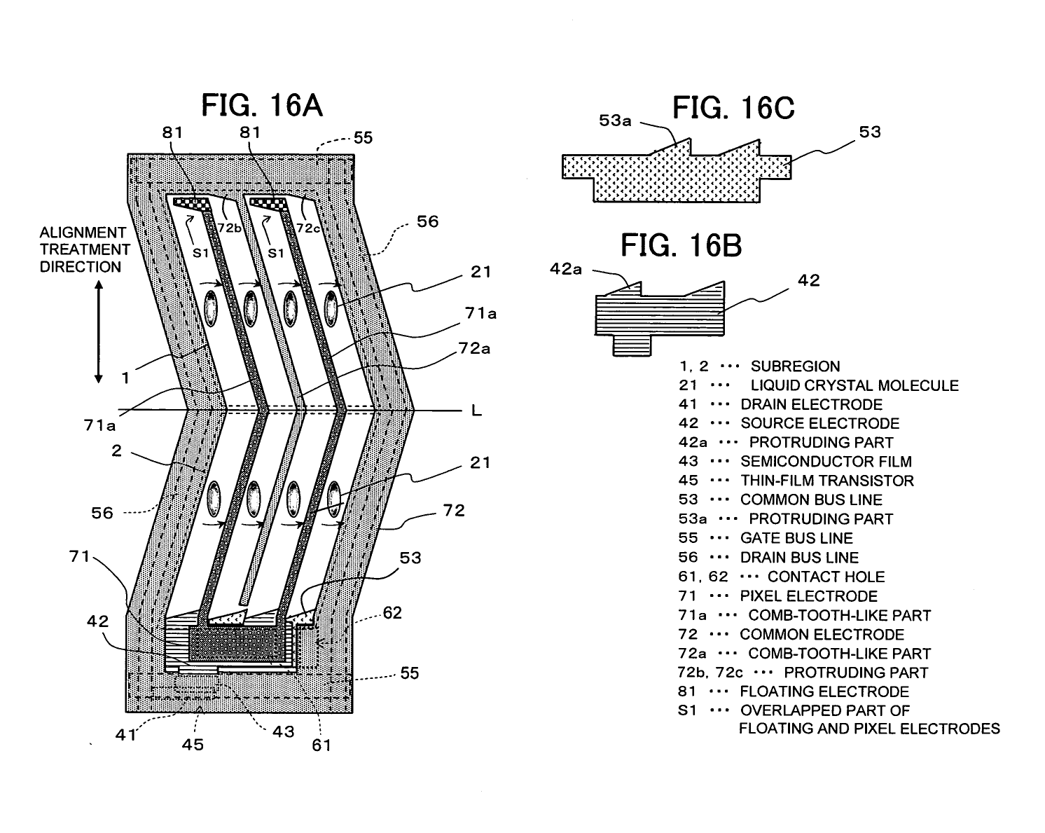

FIG. 16 shows a LCD device according to a third embodiment. The LCD device according to the third embodiment is the same in structure as the above-described first embodiment except that the pixel electrode and the common electrode that generate the liquid-crystal driving electric field are bent to intentionally make the driving (rotating) direction of the liquid crystal molecules different in the respective regions with the said bent parts of the pixel and common electrodes. This was created with reference to the technique disclosed in the previously cited Publication No. 10-307295. Therefore, the explanation about the same structure is omitted by attaching the same reference symbols as used in the first embodiment to the same elements.

With the third embodiment, as shown in FIG. 16A, the pixel electrode 71 and the common electrode 72 that generate the liquid-crystal driving electric field comprise the comb-tooth-like parts 71a and 72 which are mated or engaged with each other, similar to the first embodiment. However, the comb-tooth-like parts 71a and 72 are bent to have an approximately V-like shape at an approximately center of the pixel region by a straight line L extending horizontally. Responsive to this, the drain bus lines 56 extending vertically are bent to have an approximately V-like shape, also. In this way, the shape of the said pixel region is bent to have an approximately V-like shape.

The said pixel region is divided into a first subregion 1 located above the line L and a second subregion 2 located below the line L. The pixel electrode 71 and the common electrode 72 are bent at a predetermined angle counterclockwise in the first subregion 1 and bent at the same angle as the first subregion 1 clockwise in the second subregion 2. The alignment treatment direction of the liquid crystal molecules 21 is set to be parallel to the vertical direction in FIG. 16A when no electric field is applied (see thick arrow in FIG. 16A).

On the side of the said pixel region close to the TFT 45 (i.e., the lower side of FIG. 16A), the floating electrodes 81 and 82 are omitted. Instead, in consideration of the reverse-rotation domain preventing structure disclosed in the previously cited Publication No. 2002-323706, the plan shapes of the source electrode 42 and the common bus line 53 are changed to those shown in FIGS. 16B and 16C, respectively. In other words, two protruding parts 42a each having an inclined side are formed at the inner side of the source electrode 42, as shown in FIG. 168. Two protruding parts 53a each having an inclined side are formed at the inner side of the common bus line 53, as shown in FIG. 16C. By the protruding parts 42a and 53a, the rotation direction of the liquid crystal molecules 21 near the protruding parts 42a and 53a when the liquid-crystal driving electric field is applied can be made along the arrows in the second subregion 2.

Moreover, on the side of the said pixel region far from the TFT 45 (i.e. the upper side of FIG. 16A), the structure is the same as the above-described second embodiment. Specifically, the floating electrodes 81 are respectively provided near the top ends of the two comb-tooth-like parts 71a of the pixel electrode 71. The floating electrodes 82 are not provided near the bottom end of the comb-tooth-like part 72a of the common electrode 72 and the upper right corner of the main part of the common electrode 72 thereof. Instead, the Inclined protruding part 72b is provided at the bottom end of the part 72a and the inclined protruding part 72c is provided at the inner side of the upper right corner thereof.

With the third embodiment having the above-described structure, in the vicinities of the top ends of the comb-tooth-like parts 71a of the pixel electrode 71 and the bottom end of the comb-tooth-like part 72a of the common electrode 72 (which belong to the first subregion 1), a similar inclined electric field to that of FIG. 14 is generated. In the vicinities of the bottom ends of the comb-tooth-like parts 71a of the pixel electrode 71 and the top end of the comb-tooth-like part 72a of the common electrode 72 (which belong to the second subregion 2), a similar inclined electric field to that obtained by reversing the electric field of FIG. 14 with respect to the line L is generated. Therefore, the liquid crystal molecules 21 in the said pixel region are rotated clockwise or counterclockwise similar to the ordinary regions in the first and second subregions 1 and 2. This means that the reverse rotation domain is effectively refrained from being generated. As a result, not only improved image quality is obtainable but also an LCD device having improved reliability is realizable.

The liquid-crystal driving electric field under application of the liquid-crystal driving voltage is slightly inclined counterclockwise in the first subregion 1 with respect to the horizontal direction (i.e. the direction of the line L) and slightly Inclined clockwise in the second subregion 2 with respect to the horizontal direction. Accordingly, the liquid crystal molecules 21, which have been uniformly aligned along the vertical direction of FIG. 16A when no electric field is applied, are rotated clockwise in the first subregion 1 and counterclockwise in the second subregion 2, by the liquid-crystal driving electric field. In this way, because the rotation direction of the molecules 21 is different from each other in the first and second subregions 1 and 2, there is an advantage that the display coloring due to the change of the viewing angle can be restrained.

### Variations

The above-described first to third embodiments are preferred embodied examples of the present invention. Therefore, it is needless to say that the present invention is not limited to these embodiments. Any other modification is applicable to the embodiments.

For example, in the above-described embodiments of the invention, the floating electrodes provided near the comb-tooth-like part of the pixel or common electrode or the corner of the main part of the common electrode are formed to have an approximately L-like shape. However, they may be formed to have any other shape as necessary if the above-described relationship of the capacitances is satisfied.

Moreover, in the above-described embodiments of the invention, supposing that the floating electrode provided near the comb-tooth-like part of the pixel electrode and the comb-tooth-like part of the common electrode overlapped therewith are unified, they assume an approximately L-like bent shape. The rotation direction obtained by tracing the bent shape from the top end of the said floating electrode to the comb-tooth-like part of the pixel electrode by way of the overlapped part is in accordance with the normal rotation direction of the molecules of the liquid crystal. However, the shapes of the floating electrode and the comb-tooth-like part of the pixel electrode are not limited to these. If the rotation direction obtained by tracing the shape is in accordance with the normal rotation direction of the liquid crystal molecules, any other shape may be used.

Furthermore, in the above-described embodiments of the invention, the floating electrode for the common electrode is provided in addition to the floating electrode for the pixel electrode. However, the floating electrode or protruding part for the common electrode may be omitted if a desired magnitude ratio of the capacitances is obtained by providing only the floating electrode for the pixel electrode.

While the preferred forms of the present invention have been described, it is to be understood that modifications will be apparent to those skilled in the art without departing from the spirit of the invention. The scope of the present invention, therefore is to be determined solely by the following claims.

What is claimed is:

1. A lateral electric field type liquid-crystal display device comprising:
a first substrate and a second substrate arranged to be opposite to each other at an approximately constant interval;
a liquid crystal arranged between the first and second substrates; and
a first liquid-crystal driving electrode and a second liquid-crystal driving electrode, which are formed on one of the first and second substrates;
wherein an alignment direction of molecules of the liquid crystal is rotated in a plane approximately parallel to the first and second substrates to display images by applying a liquid-crystal driving electric field approximately parallel to the first and second substrates to the liquid crystal using the first and second liquid-crystal driving electrodes;
the first and second liquid-crystal driving electrodes comprise comb-tooth-like parts extending approximately parallel to each other and being meshed with each other, respectively, in a region where images are displayed by applying the liquid-crystal driving electric field to the liquid crystal;
an electrically isolated first floating electrode is provided in a vicinity of a top end of the comb-tooth-like part of the first liquid-crystal driving electrode, where the first floating electrode comprises an overlapped part which is overlapped with the top end by way of an insulating film; and
a capacitance intervening between the first floating electrode and the first liquid-crystal driving electrode is greater than a capacitance intervening between the first floating electrode and the second liquid-crystal driving electrode.

2. The device according to claim 1, wherein supposing that the first floating electrode and the comb-tooth-like part of the first liquid-crystal driving electrode overlapped therewith are unified, the first floating electrode and the comb-tooth-like part of the first liquid-crystal driving electrode assume an approximately L-like bent shape; and
a rotation direction obtained by tracing the bent shape from the top end of the first floating electrode to the comb-tooth-like part of the first liquid-crystal driving electrode by way of the overlapped part is in accordance with a normal rotation direction of the molecules of the liquid crystal.

3. The device according to claim 1, further comprising an electrically isolated second floating electrode provided in a vicinity of a bottom end of the comb-tooth-like part of the second liquid-crystal driving electrode:
wherein the second floating electrode comprises an overlapped part which is overlapped with the bottom end by way of an insulating film; and
a capacitance intervening between the second floating electrode and the second liquid-crystal driving electrode is greater than a capacitance intervening between the second floating electrode and the first liquid-crystal driving electrode.

4. The device according to claim 3, wherein the second floating electrode is located on a different layer from that of the first floating electrode.

5. The device according to claim 1, further comprising an electrically isolated third floating electrode provided in a vicinity of a top end of the comb-tooth-like part of the second liquid-crystal driving electrode;
wherein the third floating electrode comprises an overlapped part which is overlapped with the top end by way of an insulating film; and
a capacitance intervening between the third floating electrode and the second liquid-crystal driving electrode is greater than a capacitance intervening between the third floating electrode and the first liquid-crystal driving electrode.

6. The device according to claim 1, further comprising an electrically isolated fourth floating electrode provided in a vicinity of a bottom end of the comb-tooth-like part of the first liquid-crystal driving electrode;
wherein the fourth floating electrode comprises an overlapped part which is overlapped with the bottom end by way of an insulating film; and
a capacitance intervening between the fourth floating electrode and the first liquid-crystal driving electrode is greater than a capacitance intervening between the fourth floating electrode and the second liquid-crystal driving electrode.

7. The device according to claim 1, wherein the second liquid-crystal driving electrode comprises a protruding part in a vicinity of a bottom end of the comb-tooth-like part thereof; and
the protruding part is formed by protruding the comb-tooth-like part of the second liquid-crystal driving electrode toward the comb-tooth-like part of the first liquid-crystal driving electrode.

8. The device according to claim 1, further comprising a common bus line electrically connected to the second liquid-crystal driving electrode;
wherein the common bus line comprises a protruding part formed to protrude toward a top end of the comb-tooth-like part of the second liquid-crystal driving electrode.

9. The device according to claim 1, further comprising a source electrode of a thin-film transistor, which is electrically connected to the first liquid-crystal driving electrode;
wherein the source electrode comprises a protruding part formed to protrude toward a bottom end of the comb-tooth-like part of the first liquid-crystal driving electrode.

10. The device according to claim 1, wherein the region where images are displayed by applying the liquid-crystal driving electric field to the liquid crystal is divided by a dividing line into a first subregion including a thin-film transistor and a second subregion not including a thin-film transistor; and
the first and second subregions are bent to have an approximately V-like shape.
